(19) United States
(12) Patent Application Publication
(10) Pub. No.: US 2025/0386264 A1
(43) Pub. Date: Dec. 18, 2025

(54) METHOD OF USER EQUIPMENT (UE) AND UE

(71) Applicant: NEC Corporation, Minato-ku, Tokyo (JP)

(72) Inventors: Kundan TIWARI, Tokyo (JP); Toshiyuki TAMURA, Ibaraki (JP); Iskren IANEV, Tokyo (JP)

(73) Assignee: NEC Corporation, Minato-ku, Tokyo (JP)

(21) Appl. No.: 18/877,313

(22) PCT Filed: Jul. 24, 2023
(86) PCT No.: PCT/JP2023/026922

§ 371 Date: Dec. 20, 2024

(30) Foreign Application Priority Data
Jul. 28, 2022 (IN) 202211043223

(51) Int. Cl. H04W 36/08; H04W 60/00; H04W 84/04

(52) U.S. Cl. CPC H04W 36/08; H04W 60/002; H04W 84/042

(57) ABSTRACT

An aspect of this disclosure includes a method of a User Equipment (UE). The method includes communicating with an Access and Mobility Management Function (AMF). The method includes selecting a first Network Slice Access Stratum (AS) Group (NSAG) and a first NSAG priority based on Allowed Network Slice Selection Assistance Information (NSSAI) and Pending NSSAI.

### TECHNICAL FIELD

The present disclosure relates to a method of a user equipment (UE), a method of a communication apparatus, a method of a Radio Access Network (RAN) node, a UE, a communication apparatus, and a Radio Access Network (RAN) node.

### BACKGROUND ART

A Network Slice-Specific Authentication and Authorization (NSSAA) procedure was introduced in 3GPP Release 16. This procedure enables to perform a network slice specific authentication and authorization with an AAA server (the AAA server may be located in an external network).

When a UE requests to access to S-NSSAI(s), a serving PLMN performs the NSSAA procedure for the S-NSSAI(s) of a HPLMN which is subject to a NSSAA procedure based on subscription information. When the UE sends a Registration request message including S-NSSAI(s) in Requested NSSAI that is subject to the NSSAA procedure, an AMF sends a Registration accept message including a list of Pending NSSAI (or the Pending NSSAI) which includes the network slice(s) (e.g. the S-NSSAI(s)) subject to the NSSAA procedure. After completion of the UE Registration procedure, the AMF initiates the NSSAA procedure for the S-NSSAI(s) in the Pending NSSAI. If the NSSAA procedure is successful, the AMF informs the UE that the S-NSSAI(s) in the Pending NSSAI are now usable and let the UE to remove that S-NSSAI(s) from the storage of the Pending NSSAI in the UE and put them to the storage of the Allowed NSSAI in the UE.

3GPP specification(s) further defines a mechanism that the Registration procedure can be initiated by the UE while the NSSAA procedure is ongoing. In this case, the UE does not include the S-NSSAI(s) which the UE stores in the Pending NSSAI to the Requested NSSAI according to NPL 1.

In 3GPP Release 17 a Network Slice Based Cell Reselection feature was introduced. This feature enables the UE to perform cell-reselection based on network slice(s) that is managed in the NAS layer in the UE. As there is a case where each cell has a limited support of S-NSSAI(s), the UE may tune to a right cell using the Network Slice Based Cell Reselection feature based on the S-NSSAI(s) that the UE is interested in. When the NAS layer in the UE decides to perform the Network Slice Based Cell Reselection, the NAS layer in the UE informs a Network Slice Access Stratum (AS) Group(s) (NSAG(s)) and their priorities to the AS layer of the UE. Then, the AS layer of the UE may perform the cell reselection, based on the received NSAG(s) and their priorities from the NAS layer, by referring to supported NSAG(s) of neighbouring cell(s) over the SIB where the UE can receive.

There are basically the following two cases how the NAS layer in the UE selects the NSAG(s):
Based on the S-NSSAI(s) in the Allowed NSSAI. This is a case where the UE seeks the best cell for having a maximum support of S-NSSAI(s) in the Allowed NSSAI.
Based on a new set of S-NSSAI(s). This is a case where the UE intends to register with a new set of S-NSSAI(s) with a Requested NSSAI different from the current Allowed NSSAI.

### CITATION LIST

### Non Patent Literature

NPL 1: 3GPP TS 24.501: “Non-Access-Stratum (NAS) protocol for 5G System (5GS) Stage 3”. V17.7.1 (2022-06)
NPL 2: 3GPP TS 23.501: “System architecture for the 5G System (5GS)”. V17.5.0 (2022-06)
NPL 3: 3GPP TR 21.905: “Vocabulary for 3GPP Specifications”. V17.1.0 (2021-12)
NPL 4: 3GPP TS 23.502: “Procedures for the 5G System (5GS)”. V17.5.0 (2022-06)
NPL 5: 3GPP TS 37.340: “Evolved Universal Terrestrial Radio Access (E-UTRA) and NR Multi-connectivity stage 2”. V17.1.0 (2022-06)
NPL 6: 3GPP TS 38.423: “NG-RAN Xn application protocol (XnAP)”. V17.1.0 (2022-06)
NPL 7: 3GPP TS 23.503: “Policy and charging control framework for the 5G System (5GS) Stage 2”. V17.5.0 (2022-06)

### SUMMARY OF INVENTION

### Technical Problem

In the current 3GPP specifications, there is unclear situation(s). For example, in the current 3GPP specifications, there is unclear situation(s) regarding the Network Slice Based Cell Reselection feature and regarding the NSAG etc.

For example, according to NPL 2, it is not clear how the S-NSSAI(s) in the Pending NSSAI of the UE are to be used when the UE initiates the Network Slice Based Cell Reselection feature.

When the NAS layer of the UE initiates the Network Slice Based Cell Reselection feature based on the S-NSSAI(s) in the Allowed NSSAI, the NSAG(s) and their priorities may be chosen without taking the S-NSSAI(s) in the Pending NSSAI into account.

If the NSSAA procedure for the S-NSSAI(s) in the Pending NSSAI are successfully performed, the newly selected cell which is selected after the Network Slice Based Cell Reselection may not support the S-NSSAI(s) that were in the Pending NSSAI before the NSSAA procedure has completed but have been added to the Allowed NSSAI as result of a successful NSSAA procedure.

In this case, all services on the S-NSSAI(s) that are newly added to the Allowed NSSAI after the NSSAA procedure may not work as the newly selected cell does not support the S-NSSAI(s).

This may cause a significant service degradation for all services that use the network slice(s) with the NSSAA procedure required in 5GS.

In addition, for example, it is not clear how the source RAN chooses candidate cell(s) for handover when the UE in CM-CONNECTED state travers a boundary of the Registration Area. If the source RAN chooses target cell(s) based on the neighboring cell list, a chosen cell might not support the NSAG(s) and thus the S-NSSAI(s) in the Allowed NSSAI may not be maintained.

This may cause an unnecessary service termination for all services that use the S-NSSAI(s) in the Allowed NSSAI.

### Solution to Problem

In one aspect, a method of a User Equipment (UE), the method comprising: communicating with an Access and Mobility Management Function (AMF);

and selecting a first Network Slice Access Stratum (AS) Group (NSAG) and a first NSAG priority based on Allowed Network Slice Selection Assistance Information (NSSAI) and Pending NSSAI.

In one aspect, a method of a User Equipment (UE), the method comprising:
communicating with an Access and Mobility Management Function (AMF); and
selecting a first Network Slice Access Stratum (AS) Group (NSAG) and a first NSAG priority based on first Allowed Network Slice Selection Assistance Information (NSSAI) after Network Slice-Specific Authentication and Authorization (NSSAA) procedure for Single Network Slice Selection Assistance Information (S-NSSAI) included in Pending NSSAI completes successfully,
wherein the first Allowed NSSAI includes the S-NSSAI.

In one aspect, a method of a communication apparatus, the method comprising:
receiving a first Network Slice Access Stratum (AS) Group (NSAG) and a first NSAG priority; and
sending the first NSAG and the first NSAG priority.

In one aspect, a method of a Radio Access Network (RAN) node, the method comprising:
receiving a first Network Slice Access Stratum (AS) Group (NSAG) and a first NSAG priority; and
selecting a cell for handover based on the first NSAG and the first NSAG priority.

In one aspect, a User Equipment (UE) comprising:
means for communicating with a communication apparatus; and
means for selecting a first Network Slice Access Stratum (AS) Group (NSAG) and a first NSAG priority based on Allowed Network Slice Selection Assistance Information (NSSAI) and Pending NSSAI.

In one aspect, a User Equipment (UE) comprising:
means for communicating with a communication apparatus; and
means for selecting a first Network Slice Access Stratum (AS) Group (NSAG) and a first NSAG priority based on first Allowed Network Slice Selection Assistance Information (NSSAI) after Network Slice-Specific Authentication and Authorization (NSSAA) procedure for Single Network Slice Selection Assistance Information (S-NSSAI) included in Pending NSSAI completes successfully,
wherein the first Allowed NSSAI includes the S-NSSAI.

In one aspect, a communication apparatus comprising:
means for receiving a first Network Slice Access Stratum (AS) Group (NSAG) and a first NSAG priority; and
means for sending the first NSAG and the first NSAG priority.

In one aspect, a Radio Access Network (RAN) node comprising:
means for receiving a first Network Slice Access Stratum (AS) Group (NSAG) and a first NSAG priority; and
means for selecting a cell for handover based on the first NSAG and the first NSAG priority.

### BRIEF DESCRIPTION OF DRAWINGS

FIG. 1 is a signaling diagram of a First example of the First Aspect.

FIG. 2 is a signaling diagram of a Second example of the First Aspect.

FIG. 3 is a signaling diagram of a First example of the Second Aspect.

FIG. 4 is a diagram illustrating a system overview.

FIG. 5 is a block diagram illustrating a UE.

FIG. 6 is a block diagram illustrating an (R)AN node.

FIG. 7 is a diagram illustrating System overview of (R)AN node based on O-RAN architecture.

FIG. 8 is a block diagram illustrating an RU.

FIG. 9 is a block diagram illustrating a DU.

FIG. 10 is a block diagram illustrating a CU.

FIG. 11 is a block diagram illustrating an AMF.

FIG. 12 is a block diagram illustrating a PCF.

FIG. 13 is a block diagram illustrating an AUSF.

FIG. 14 is a block diagram illustrating a UDM.

FIG. 15 is a block diagram illustrating an NSSF.

### DESCRIPTION OF EXAMPLE EMBODIMENTS

### Abbreviations

For the purposes of the present document, the abbreviations given in 3GPP TR 21.905 [1] and the following apply. An abbreviation defined in the present document takes precedence over the definition of the same abbreviation, if any, in 3GPP TR 21.905 [1].
4G-GUTI 4G Globally Unique Temporary UE Identity
5GC 5G Core Network
5GLAN 5G Local Area Network
5GS 5G System
5G-AN 5G Access Network
5G-AN PDB 5G Access Network Packet Delay Budget
5G-EIR 5G-Equipment Identity Register
5G-GUTI 5G Globally Unique Temporary Identifier
5G-BRG 5G Broadband Residential Gateway
5G-CRG 5G Cable Residential Gateway
5G GM 5G Grand Master
5G-RG 5G Residential Gateway
5G-S-TMSI 5G S-Temporary Mobile Subscription Identifier
5G VN 5G Virtual Network
5QI 5G QOS Identifier
AF Application Function
AMF Access and Mobility Management Function
AMF-G Geographically selected Access and Mobility Management Function
AMF-NG Non-Geographically selected Access and Mobility Management Function
ANDSF Access Network Discovery and Selection Function
ARFCN Absolute radio-frequency channel number
AS Access Stratum
ATSSS Access Traffic Steering, Switching, Splitting
ATSSS-LL ATSSS Low-Layer
AUSF Authentication Server Function
AUTN Authentication token
BCCH Broadcast Control Channel
BMCA Best Master Clock Algorithm
BSF Binding Support Function
CAG Closed Access Group
CAPIF Common API Framework for 3GPP northbound APIs
CHF Charging Function
CN PDB Core Network Packet Delay Budget
CP Control Plane
DAPS Dual Active Protocol Stacks
DL Downlink
DN Data Network
DNAI DN Access Identifier
DNN Data Network Name
DRX Discontinuous Reception
DS-TT Device-side TSN translator
ePDG evolved Packet Data Gateway
EBI EPS Bearer Identity
EPS Evolved Packet System
EUI Extended Unique Identifier
FAR Forwarding Action Rule
FN-BRG Fixed Network Broadband RG
FN-CRG Fixed Network Cable RG
FN-RG Fixed Network RG
FQDN Fully Qualified Domain Name
GFBR Guaranteed Flow Bit Rate
GMLC Gateway Mobile Location Centre
GPSI Generic Public Subscription Identifier
GUAMI Globally Unique AMF Identifier
GUTI Globally Unique Temporary UE Identity
HPLMN Home Public Land Mobile Network
HR Home Routed (roaming)
IAB Integrated access and backhaul
IMEI/TAC IMEI Type Allocation Code
IPUPS Inter PLMN UP Security
I-SMF Intermediate SMF
I-UPF Intermediate UPF
LADN Local Area Data Network
LBO Local Break Out (roaming)
LMF Location Management Function
LoA Level of Automation
LPP LTE Positioning Protocol
LRF Location Retrieval Function
MCC Mobile country code
MCX Mission Critical Service
MDBV Maximum Data Burst Volume
MFBR Maximum Flow Bit Rate
MICO Mobile Initiated Connection Only
MITM Man In the Middle
MNC Mobile Network Code
MPS Multimedia Priority Service
MPTCP Multi-Path TCP Protocol
N3IWF Non-3GPP InterWorking Function
N3GPP Non-3GPP access
N5CW Non-5G-Capable over WLAN
NAI Network Access Identifier
NAS Non-Access-Stratum
NEF Network Exposure Function
NF Network Function
NGAP Next Generation Application Protocol
NID Network identifier
NPN Non-Public Network
NR New Radio
NSAG Network Slice Access Stratum Group
NRF Network Repository Function
NSI ID Network Slice Instance Identifier
NSSAA Network Slice-Specific Authentication and Authorization
NSSAAF Network Slice-Specific Authentication and Authorization Function
NSSAI Network Slice Selection Assistance Information
NSSF Network Slice Selection Function
NSSP Network Slice Selection Policy
NSSRG Network Slice Simultaneous Registration Group
NW-TT Network-side TSN translator
NWDAF Network Data Analytics Function
PCF Policy Control Function
PCO Protocol Configuration Options
PDB Packet Delay Budget
PDR Packet Detection Rule
PDU Protocol Data Unit
PEI Permanent Equipment Identifier
PER Packet Error Rate
PFD Packet Flow Description
PLMN Public Land Mobile Network
PNI-NPN Public Network Integrated Non-Public Network
PPD Paging Policy Differentiation
PPF Paging Proceed Flag
PPI Paging Policy Indicator
PSA PDU Session Anchor
PTP Precision Time Protocol
QFI QoS Flow Identifier
QOE Quality of Experience
RACS Radio Capabilities Signalling optimisation
(R)AN (Radio) Access Network
RAT Radio Access Technology
RG Residential Gateway
RIM Remote Interference Management
RQA Reflective QoS Attribute
RQI Reflective QoS Indication
RSN Redundancy Sequence Number
SA NR Standalone New Radio
SBA Service Based Architecture
SBI Service Based Interface
SCP Service Communication Proxy
SD Slice Differentiator
SEAF Security Anchor Functionality
SEPP Security Edge Protection Proxy
SIB System Information Block
SMF Session Management Function
SMSF Short Message Service Function
SN Sequence Number
SN name Serving Network Name.
SNPN Stand-alone Non-Public Network
S-NSSAI Single Network Slice Selection Assistance Information
SSC Session and Service Continuity
SSCMSP Session and Service Continuity Mode Selection Policy
SST Slice/Service Type
SUCI Subscription Concealed Identifier
SUPI Subscription Permanent Identifier
SV Software Version
TMSI Temporary Mobile Subscriber Identity
TNAN Trusted Non-3GPP Access Network
TNAP Trusted Non-3GPP Access Point
TNGF Trusted Non-3GPP Gateway Function
TNL Transport Network Layer
TNLA Transport Network Layer Association
TSC Time Sensitive Communication
TSCAI TSC Assistance Information
TSN Time Sensitive Networking
TSN GM TSN Grand Master
TSP Traffic Steering Policy
TT TSN Translator
TWIF Trusted WLAN Interworking Function
UCMF UE radio Capability Management Function
UDM Unified Data Management
UDR Unified Data Repository
UDSF Unstructured Data Storage Function
UE User Equipment
UL Uplink
UL CL Uplink Classifier
UPF User Plane Function
UPSI UE Policy Section Identifier
URLLC Ultra Reliable Low Latency Communication
URRP-AMF UE Reachability Request Parameter for AMF
URSP UE Route Selection Policy
VID VLAN Identifier
VLAN Virtual Local Area Network
VPLMN Visited Public Land Mobile Network
W-5GAN Wireline 5G Access Network
W-5GBAN Wireline BBF Access Network
W-5GCAN Wireline 5G Cable Access Network
W-AGF Wireline Access Gateway Function

### Definitions

For the purposes of the present document, the terms and definitions given in NPL 3 and the following apply. A term defined in the present document takes precedence over the definition of the same term, if any, in NPL 3.

### GENERAL

Those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the Aspects of the present disclosure so as not to obscure the figures with details that will be readily apparent to those skilled in the art having the benefit of the description herein.

For the purpose of promoting an understanding of the principles of the disclosure, reference will now be made to the Aspect illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or entities or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an Aspect”, “in another Aspect” and similar language throughout this specification may, but not necessarily do, all refer to the same Aspect.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which may be defined to have the following meanings. The singular forms “a”, “an”, and “the” include plural references unless the context clearly dictates otherwise.

As used herein, information is associated with data and knowledge, as data is meaningful information and represents the values attributed to parameters. Further knowledge signifies understanding of an abstract or concrete concept. Note that this example system is simplified to facilitate description of the disclosed subject matter and is not intended to limit the scope of this disclosure. Other devices, systems, and configurations may be used to implement the Aspects disclosed herein in addition to, or instead of, a system, and all such Aspects are contemplated as within the scope of the present disclosure.

Each of Aspects and elements included in each Aspects described below may be implemented independently or in combination with any other. These Aspects include novel characteristics different from one another. Accordingly, these Aspects contribute to achieving objects or solving problems different from one another and contribute to obtaining advantages different from one another.

An example object of this disclosure is to provide a method and apparatus that can solve the above problem.

The following list explains intended interpretation of terms being used in this disclosure:
Subscribed S-NSSAI, Subscribed S-NSSAIs or Subscribed S-NSSAI(s): It can be equal to a list of S-NSSAIs in the Subscribed NSSAI.
Allowed S-NSSAI, Allowed S-NSSAIs or Allowed S-NSSAI(s): It can be equal to a list of S-NSSAIs in the Allowed NSSAI.
Configured S-NSSAI, Configured S-NSSAIs or Configured S-NSSAI(s): It can be equal to a list of S-NSSAIs in the Configured NSSAI.
Rejected S-NSSAI, Rejected S-NSSAIs or Rejected S-NSSAI(s): It can be equal to a list of S-NSSAIs in the Rejected NSSAI.
Pending S-NSSAI, Pending S-NSSAIs or Pending S-NSSAI(s): It can be equal to a list of S-NSSAIs in the Pending NSSAI.

The Network Slice Based Cell Reselection may be expressed as Network Slice based cell reselection.

A method of a User Equipment (UE) according to example aspect of this disclosure includes communicating with an Access and Mobility Management Function (AMF). The method includes selecting a first Network Slice Access Stratum (AS) Group (NSAG) and a first NSAG priority based on Allowed Network Slice Selection Assistance Information (NSSAI) and Pending NSSAI.

A method of a User Equipment (UE) according to example aspect of this disclosure includes communicating with an Access and Mobility Management Function (AMF). The method includes selecting a first Network Slice Access Stratum (AS) Group (NSAG) and a first NSAG priority based on first Allowed Network Slice Selection Assistance Information (NSSAI) after Network Slice-Specific Authentication and Authorization (NSSAA) procedure for Single Network Slice Selection Assistance Information (S-NSSAI) included in Pending NSSAI completes successfully. The first Allowed NSSAI includes the S-NSSAI.

A method of a communication apparatus according to example aspect of this disclosure includes receiving a first Network Slice Access Stratum (AS) Group (NSAG) and a first NSAG priority. The method includes sending the first NSAG and the first NSAG priority.

A method of a Radio Access Network (RAN) node according to example aspect of this disclosure includes receiving a first Network Slice Access Stratum (AS) Group (NSAG) and a first NSAG priority. The method includes selecting a cell for handover based on the first NSAG and the first NSAG priority.

A User Equipment (UE) according to example aspect of this disclosure includes a memory, and at least one hardware processor coupled to the memory. The at least one hardware processor is configured to communicate with a communication apparatus. The at least one hardware processor is configured to select a first Network Slice Access Stratum (AS) Group (NSAG) and a first NSAG priority based on Allowed Network Slice Selection Assistance Information (NSSAI) and Pending NSSAI.

A User Equipment (UE) according to example aspect of this disclosure includes a memory, and at least one hardware processor coupled to the memory.

The at least one hardware processor is configured to communicate with a communication apparatus. The at least one hardware processor is configured to select a first Network Slice Access Stratum (AS) Group (NSAG) and a first NSAG priority based on first Allowed Network Slice Selection Assistance Information (NSSAI) after Network Slice-Specific Authentication and Authorization (NSSAA) procedure for Single Network Slice Selection Assistance Information (S-NSSAI) included in Pending NSSAI completes successfully. The first Allowed NSSAI includes the S-NSSAI.

A communication apparatus according to example aspect of this disclosure includes a memory, and at least one hardware processor coupled to the memory. The at least one hardware processor is configured to receive a first Network Slice Access Stratum (AS) Group (NSAG) and a first NSAG priority. The at least one hardware processor is configured to send the first NSAG and the first NSAG priority.

A Radio Access Network (RAN) node according to example aspect of this disclosure includes a memory, and at least one hardware processor coupled to the memory. The at least one hardware processor is configured to receive a first Network Slice Access Stratum (AS) Group (NSAG) and a first NSAG priority. The at least one hardware processor is configured to select a cell for handover based on the first NSAG and the first NSAG priority.

### <First Aspect>

When a NAS layer of a UE 3 (a UE NAS 301) initiates the Network Slice Based Cell Reselection feature based on the S-NSSAI(s) in the Allowed NSSAI, the NSAG(s) and their priorities are chosen based on both the S-NSSAI(s) in the Allowed NSSAI and the S-NSSAI(s) in the Pending NSSAI.

### First Example of the First Aspect

A First example of the First Aspect discloses a method where the UE NAS 301 selects NSAG(s) and NSAG priority (or NSAG(s) priorities) based on both, the Allowed NSSAI and the Pending NSSAI for the Network Slice Based Cell Reselection and the selected NSAG(s) and the NSAG priority (or NSAG priorities) are sent to a AS layer of the UE (a UE AS 302).

After the NSSAA procedure is completed, the UE NAS 301 checks the Allowed NSSAI and if there is a difference from the one before the NSSAA procedure, then the UE NAS 301 selects NSAG and NSAG priority based on Allowed NSSAI as there is no Pending NSSAI at this moment and the UE NAS 301 sends the selected NSAG and NSAG priority to the AS layer of the UE (the UE AS 302).

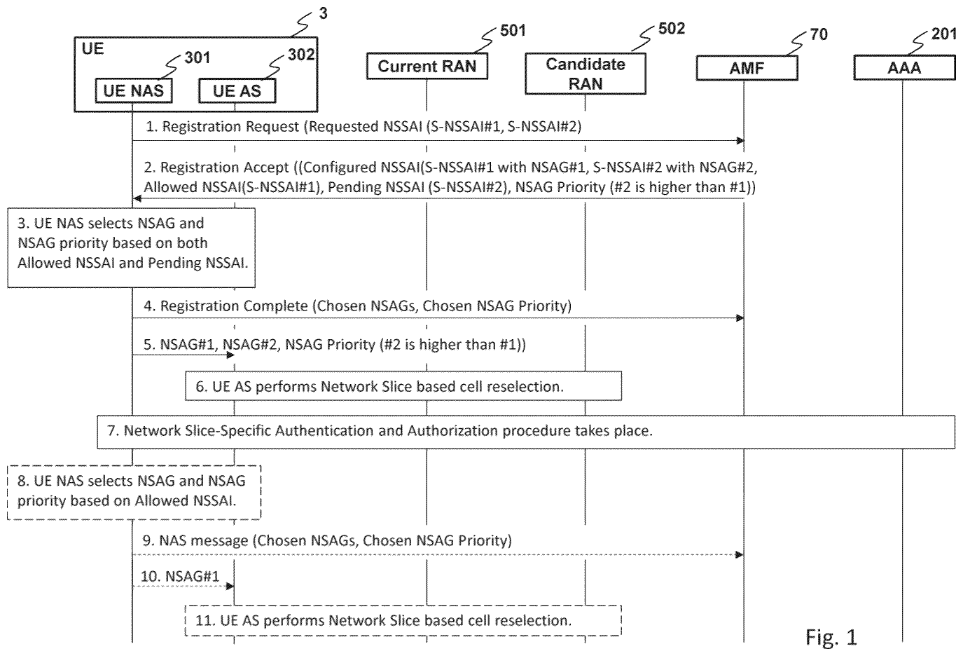

The detailed processes of the First example of the First Aspect are described below, with reference to FIG. 1.

Step 1. The UE NAS 301 sends a Registration Request message to an AMF 70 including S-NSSAI #1 and S-NSSAI #2 in the Requested NSSAI.

Step 2. The AMF 70 sends a Registration Accept message to the UE NAS 301 including Configured NSSAI, Allowed NSSAI, Pending NSSAI and NSAG Priority.

The Configured NSSAI includes the S-NSSAI #1 with the associated NSAG #1, the S-NSSAI #2 with the associated NSAG #2 and the S-NSSAI #3 with the associated NSAG #3.

The Allowed NSSAI includes the S-NSSAI #1 as the S-NSSAI #1 is the network slice that the UE 3 is allowed to use.

Here, NSAG information in the Registration Accept message may include the relationship between S-NSSAI and NSAG (i.e. the S-NSSAI #1 with the associated NSAG #1, the S-NSSAI #2 with the associated NSAG #2 and the S-NSSAI #3 with the associated NSAG #3).

The Pending NSSAI includes the S-NSSAI #2 as the S-NSSAI #2 is subject for the NSSAA procedure based on subscriber data in the home network (HPLMN).

The NSAG Priority indicates a priority order among the NSAGs. For example, the NSAG Priority may indicate that NSAG #2 has a higher priority than NSAG #1.

Step 3. Upon reception of the Registration Accept message in step 2, the UE NAS 301 selects a NSAG and a NSAG priority based on both S-NSSAI(s) in the Allowed NSSAI and S-NSSAI(s) in the Pending NSSAI. I.E., the UE NAS 301 assumes that the NSSAA procedure for all S-NSSAI(s) in the Pending NSSAI will be successfully completed. For example, the UE NAS 301 may select NSAG #1 and NSAG #2 as the NSAG based on the Allowed NSSAI and the Pending NSSAI. For example, the UE NAS 301 may select or decide that NSAG #2 has a higher priority than NSAG #1 as the NSAG priority based on at least one of the Allowed NSSAI, the Pending NSSAI and the NSAG Priority.

Step 4. The UE NAS 301 sends a Registration Complete message to the AMF 70 including Chosen NSAGs and Chosen NSAG Priority.

The Chosen NSAGs includes the selected NSAG(s) in step 3. The Chosen NSAG Priority includes the NSAG priority decided in step 3. The Chosen NSAGs may be expressed as selected NSAGs or derived NSAGs. The Chosen NSAG Priority may be expressed as selected NSAG Priority or derived NSAG Priority or decided NSAG Priority.

For example, the Chosen NSAGs may include NSAG #1 and NSAG #2. For example, the Chosen NSAG Priority may include the NSAG priority indicating that NSAG #2 has a higher priority than NSAG #1.

Upon reception of the Registration Complete message, the AMF 70 stores the Chosen NSAGs and the Chosen NSAG Priority in the UE context in the AMF 70. The AMF 70 (e.g., the AMF 70 as an initial AMF) may send the Chosen NSAGs and the Chosen NSAG Priority to the Target AMF during the Registration with AMF re-allocation procedure takes place according to NPL 4.

The AMF 70 may inform the Chosen NSAGs and the Chosen NSAG Priority to a RAN 5 (e.g., a RAN node) whenever the AMF 70 associates with the RAN 5. For example, Initial Context Setup request message, UE Context Modification Request message, Connection Establishment Indication message, AMF CP Relocation Indication message, UE Information Transfer message, UE Context Suspend Response message, UE Context Resume Response message, Handover Command message, Handover Request message, Path Switch Acknowledge message, Downlink RAN Status Transfer message, Handover Success message, Downlink RAN Early Status Transfer message, Paging message or any other existing or new NGAP message includes the Chosen NSAGs and the Chosen NSAG Priority and transfers them from the AMF 70 to the RAN 5. The AMF 70 may also activate or de-activate the network slice support and priority based handover in the RAN 5 by including a new parameter or flag in the above listed messages between the AMF 70 and the RAN 5 for the purpose of activating or de-activating the network slice support and priority considerations by the RAN 5 in connected mode mobility, i.e. in selecting the target cell for handover or RRC connection release with redirection to a target cell. Then the RAN 5 may use the Chosen NSAGs and the Chosen NSAG Priority for selecting candidate cell(s) for handover procedure. The candidate cell(s) for handover may be chosen based on a combination of at least one of the support for NSAG(s) at the candidate cell(s) and the measured signal strength that is measured and reported by the UE 3. For example, the RAN 5 may handover the UE 3 to the selected candidate cell(s) in a case of performing the handover.

For example, in a case where the Chosen NSAGs includes NSAG #1 and NSAG #2, the RAN 5 may select the candidate cell(s) that supports at least one of NSAG #1 and NSAG #2 (e.g., the RAN 5 may select the candidate cell(s) that supports at least one of S-NSSAI #1 associated with NSAG #1 and S-NSSAI #2 associated with NSAG #2).

In addition, for example, it assumes a case where the Chosen NSAGs includes NSAG #1 and NSAG #2 and the measured signal strength of one cell that supports NSAG #1 (e.g., one cell that supports S-NSSAI #1 associated with NSAG #1) is higher than the measured signal strength of another cell that supports NSAG #2 (e.g., another cell that supports S-NSSAI #2 associated with NSAG #2). In this case, the RAN 5 may select the one cell that supports NSAG #1 as the candidate cell(s).

In addition, in a case where the RAN 5 selects the candidate cell(s), the RAN 5 may take the Chosen NSAG Priority into consideration. For example, it assumes a case where the Chosen NSAG Priority indicates that NSAG #2 has a higher priority than NSAG #1. In this case, if the RAN 5 finds one cell that supports NSAG #1 (e.g., one cell that supports S-NSSAI #1 associated with NSAG #1) and another cell that supports NSAG #2 (e.g., another cell that supports S-NSSAI #2 associated with NSAG #2) as the candidate cell(s), the RAN 5 may select the another cell.

The source RAN 5 (e.g., RAN 5 which receives the Chosen NSAGs and the Chosen NSAG Priority from the AMF 70 and which performs the handover procedure) may inform the Chosen NSAGs and the Chosen NSAG Priority to the target RAN 5. For example, Handover Request message, SN Status Transfer message, RAN Paging message and Early Status Transfer message or any other existing or new XnAP message includes the Chosen NSAGs and the Chosen NSAG Priority and transfers them from the source RAN 5 to the target RAN 5.

For example, the target RAN 5 may use the Chosen NSAGs and the Chosen NSAG Priority for selecting candidate cell(s) for handover procedure in the same manner as mentioned above.

The Target AMF which receives the Chosen NSAGs and the Chosen NSAG Priority may perform process(es) in the same manner as the AMF 70 as described above.

Step 5. The UE NAS 301 informs the selected NSAGs (e.g., NSAG #1 and NSAG #2) and NSAG Priority (e.g., the NSAG priority indicating that NSAG #2 has a higher priority than NSAG #1) to the UE AS 302.

Step 6. The UE AS 302 may perform Network Slice based cell reselection based on the selected NSAGs (e.g., NSAG #1 and NSAG #2) and NSAG Priority that are received in step 5.

In one example, the UE 3 applies the Network slice based cell reselection procedure when the UE 3 moves to CM-IDLE mode (e.g., when the network (e.g., the AMF 70) releases the current N1 signalling connection explicitly by initiating signalling in the network or when the RLF is detected in the UE 3 or in the network and the UE 3 or the network releases the N1 signalling connection locally). The UE 3 may also apply the same procedure as defined here when the UE 3 moves to RRC-INACTIVE state. The NAS layer in the UE (e.g., the UE NAS 301) may initiate the Network Slice based cell reselection feature (or the Network Slice based cell reselection) at any time.

Step 7. The Network Slice-Specific Authentication and Authorization (NSSAA) procedure takes place for the S-NSSAI #2 between UE NAS 301 and an AAA 201. The step 7 may be performed after step 4 and before step 5. Further, the order of the step 7 and the set of step 4 and step 5 may be switched. The AAA may be expressed as a AAA server.

Step 8. After the NSSAA procedure has completed, the UE NAS 301 may reselect (or select) a NSAG and decide a NSAG priority based on Allowed NSSAI only if the NSSAA procedure in step 7 fails, i.e., if one or more S-NSSAI(s) from the Pending NSSAI was unsuccessful with the NSSAA procedure. If the NSSAA procedure in step 7 was successful for all the S-NSSAI(s) from the Pending NSSAI and the S-NSSAI(s) from the Pending NSSAI were added to the Allowed NSSAI of the UE 3 by the network (e.g. the AMF 70), the UE NAS 301 does not perform NSAG and NSAG priority selection again as there is no difference as an input for NSAG selection that is taken place at step 3.

Step 9. The UE NAS 301 may send a NAS message to the AMF 70 including Chosen NSAGs and Chosen NSAG Priority to the AMF 70. The Chosen NSAGs includes the selected NSAG(s) in step 8. The Chosen NSAG Priority includes the NSAG priority decided in step 8.

For example, the NAS message can be Registration Request message, Registration Complete message, Authentication response message, UL NAS transport message, Service request message, Configuration update complete message, Identity response message, Notification response message, Security mode complete message, Network slice-specific authentication complete message or any other existing or new NAS messages which conveys the Chosen NSAGs and Chosen NSAG Priority to the AMF 70.

For example, upon reception of the NAS message in step 9, the AMF 70 may inform the Chosen NSAGs and the Chosen NSAG Priority to a RAN 5 in the same manner as step 4.

For example, the RAN 5 may use the Chosen NSAGs and the Chosen NSAG

Priority for selecting candidate cell(s) for handover procedure in the same manner as step 4.

For example, the source RAN 5 (e.g., RAN 5 which receives the Chosen NSAGs and the Chosen NSAG Priority from the AMF 70 and which performs the handover procedure) may inform the Chosen NSAGs and the Chosen NSAG Priority to the target RAN 5 in the same manner as step 4.

For example, the AMF 70 may perform same process(es) in the step 4 in a case where the AMF 70 receives the NAS message.

Step 10. The UE NAS 301 may inform the selected NSAGs (e.g., the Chosen NSAGs which includes NSAG #1 and is decided in step 8) to the UE AS 302, i.e. the NSSAA procedure for the S-NSSAI #2 has failed in this example.

The NSAG priority (e.g., the Chosen NSAG Priority decided in step 8) may also be informed to the UE AS 302. For example, the NSAG priority may also be informed to the UE AS 302 although there is only one NSAG being informed.

Step 11. The UE AS 302 may perform Network Slice based cell reselection based on the NSAG (e.g., NSAG #1) that is received in step 10.

### Variant 1 of First Example of the First Aspect

In case where the UE 3 roams to a visited PLMN (VPLMN) and the UE 3 holds the Configured NSSAI for the VPLMN, the UE 3 performs the Network Slice Based Cell Reselection based on S-NSSAI(s) (e.g., S-NSSAI(s) included in the Configured NSSAI for the VPLMN) that is intended to set in the Requested NSSAI for the Registration Request message.

### Variant 2 of First Example of the First Aspect

In step 1, when the RRC connection is established or being established, a Current RAN 501 (e.g., a RAN node which establishes or is establishing the RRC connection with the UE 3) may inform, to the UE AS 302, supported NSAG(s) that a current cell(s) supports using RRCSetup message, RRCReestablishment message, RRCReject message or any existing or new RRC message. The supported NSAG(s) may indicate NSAG(s) that the current cell(s) supports. The current cell may be controlled by the Current RAN 501. The Current RAN 501 may be a RAN or a RAN node which serves the UE 3.

Once the UE AS 302 receives the supported NSAG(s), the UE AS 302 informs it to the UE NAS 301.

The UE NAS 301 refers to the supported NSAG(s) in step 3 when the UE NAS 301 selects NSAG(s) and NSAG priority. If a chosen NSAG(s) in step 3 is included in the supported NSAG(s) that is received from the Current RAN 501, the UE NAS 301 does not activate the Network Slice based cell reselection by not sending any NSAG and their priority to the UE AS 302.

### Variant 3 of First Example of the First Aspect

In one example, the UE NAS 301 sends, to the UE AS 302, Pending NSSAI of the 3GPP access only (S-NSSAI(s) subject to the NSSAA procedure is requested over 3GPP access) for the Network Slice Based Cell Reselection.

For example, the UE AS 302 may use the Pending NSSAI of the 3GPP access with the selected NSAGs and the NSAG Priority received in step 5, for the Network Slice Based Cell Reselection. For example, the UE AS 302 may reselect cell(s) that supports S-NSSAI(s) in the Pending NSSAI of the 3GPP access in step 6.

For example, the UE NAS 301 may inform, to the UE AS 302, the selected NSAGs and the NSAG Priority regarding the 3GPP access in step 5.

For example, the UE NAS 301 may select the NSAG and NSAG priority based on both S-NSSAI(s) in the Allowed NSSAI of the 3GPP access and S-NSSAI(s) in the Pending NSSAI of the 3GPP access (e.g., the UE NAS 301 may select the NSAGs regarding the 3GPP access and the NSAG priority regarding the 3GPP access) in step 3. Then the UE NAS 301 may inform, to the UE AS 302, the selected NSAGs and the NSAG Priority regarding the 3GPP access in step 5. The UE AS 302 may perform the Network Slice Based Cell Reselection based on the NSAGs regarding the 3GPP access and the NSAG priority regarding the 3GPP access.

In one example, the UE NAS 301 sends Pending NSSAI of 3GPP access (S-NSSAI(s) subject to the NSSAA procedure is requested over 3GPP access) and Pending NSSAI of non-3GPP access (S-NSSAI(s) subject to the NSSAA procedure is requested over non-3GPP access) to the UE AS 302 for the Network Slice Based Cell Reselection.

For example, the UE AS 302 may use the Pending NSSAI of the 3GPP access and the Pending NSSAI of the non-3GPP access with the selected NSAGs and the NSAG Priority received in step 5, for the Network Slice Based Cell Reselection. For example, the UE AS 302 may reselect cell(s) that supports at least one of S-NSSAI(s) in the Pending NSSAI of the 3GPP access and S-NSSAI(s) in the Pending NSSAI of the non-3GPP access in step 6.

For example, the UE NAS 301 may inform, to the UE AS 302, the selected NSAGs and the NSAG Priority regarding at least one of the 3GPP access and the non-3GPP access in step 5.

For example, the UE NAS 301 may select the NSAG and NSAG priority taking at least one of S-NSSAI(s) in the Allowed NSSAI of the 3GPP access, S-NSSAI(s) in the Pending NSSAI of the 3GPP access, S-NSSAI(s) in the Allowed NSSAI of the non-3GPP access, S-NSSAI(s) in the Pending NSSAI of the non-3GPP access into consideration (e.g., the UE NAS 301 may select at least one of the NSAGs regarding the 3GPP access, the NSAG priority regarding the 3GPP access, the NSAGs regarding the non-3GPP access and the NSAG priority regarding the non-3GPP access) in step 3. Then the UE NAS 301 may inform, to the UE AS 302, at least one of the NSAGs regarding the 3GPP access, the NSAG priority regarding the 3GPP access, the NSAGs regarding the non-3GPP access and the NSAG priority regarding the non-3GPP access in step 5. The UE AS 302 may perform the Network Slice Based Cell Reselection based on at least one of the NSAGs regarding the 3GPP access, the NSAG priority regarding the 3GPP access, the NSAGs regarding the non-3GPP access and the NSAG priority regarding the non-3GPP access.

### Variant 4 of First Example of the First Aspect

If at step 2 during the Registration Accept or at step 7 during UE Configuration Update procedures one or more S-NSSAI(s) from the Requested NSSAI or from the Pending NSSAI were rejected for the reason of NSAC (Network Slice Admission Control) i.e. because of network slice quota was reached or exceeded, then the UE NAS 301 still considers such S-NSSAI(s) for the network slice based cell reselection and the UE NAS 301 selects the NSAG and the NSAG priority and provides to the UE AS 302 the NSAG and the NSAG priority for such S-NSSAI(s) in step 5 or step 10. The UE NAS 301 may receive information regarding NSAC (e.g., information indicating the network slice quota was reached or exceeded (i.e., S-NSSAI is not available due to maximum number of UEs reached)) from network node(s) (e.g., the AMF 70 or an SMF). For example, even if S-NSSAI(s) in the Requested NSSAI or in the Pending NSSAI is rejected for the reason of the NSAC, the UE NAS 301 may still consider such S-NSSAI(s) for the network slice based cell reselection and the UE NAS 301 may select the NSAG and the NSAG priority in step 3 or step 8 and provides to the UE AS 302 the NSAG and the NSAG priority for such S-NSSAI(s) in step 5 or step 10. For example, regardless of a result or status of the NSAC, the UE NAS 301 may select the NSAG and the NSAG priority in step 3 or step 8 and provides to the UE AS 302 the NSAG and the NSAG priority for such S-NSSAI(s) in step 5 or step 10.

### Variant 5 of First Example of the First Aspect

After the NSAGs and NSAG priority are chosen in step 3 or step 8, the UE AS 302 may send the NSAGs and NSAG priority as the Chosen NSAGs and the Chosen NSAG Priority to the newly selected RAN 5 over a RRC message.

Refer to step 4 how the newly RAN 5 uses the Chosen NSAGs and the Chosen NSAG Priority.

For example, the UE AS 302 includes the Chosen NSAGs and the Chosen NSAG Priority to the RRCSetup Request message, RRCSetup Comeplete message, RRCReconfiguration message or any other existing or new RRC messages and sends at least one of the messages to the newly selected RAN 5.

### Variant 6 of First Example of the First Aspect

When the Network Slice Based Cell Reselection takes place in the UE AS 302 in step 6 and step 11, the UE AS 302 may scan or monitor the NSAG information transmitted over the SIB (e.g., SIB16) and/or dedicated signaling in the current cell as well as in the neighboring cell(s). In case that a cell is configured as the Master Node (MN) for the multi connectivity as defined in NPL 5, the MN may transmit (i.e. broadcast) NSAG information that is supported by associated Secondary Node(s) (SN(s)) for the multi connectivity in addition to the NSAG information that is supported by the MN. The NSAG information may indicate NSAG(s) or may be information related to NSAG(s). The NSAG information that is supported by associated SN(s) may indicate at least one of NSAG(s) and their priorities related to the SN(s). When the MN broadcasts the NSAG information that is supported by the SN(s), the MN may broadcast the NSAG information together with an information that indicates an associated SN(s). The information that indicates the associated SN(s) can be Frequency band, physical cell identity or ARFCN.

When the UE AS 302 receives the NSAG information (e.g., the NSAG(s)) over the SIB (e.g., SIB16) and/or dedicated signaling of the current cell which is configured as the MN and the NSAG(s) that is supported by the SN(s) (e.g., the NSAG(s) may be indicated by the NSAG information) has the best match with the NSAG(s) that is received from the UE NAS 301, the UE 3 may stay in the current cell as the S-NSSAI(s) (or service(s) related to the S-NSSAI(s)) associated with the NSAG supported by the SN(s) can be provisioned by the multi connectivity with the SN(s) when a PDU session related to the S-NSSAI(s) is established.

For example, in a case where the UE AS 302 receives the NSAG information (e.g., the NSAG(s)) over the SIB (e.g., SIB16) and/or dedicated signaling of the neighboring cell(s) and the NSAG(s) that is supported by MN or SN(s) regarding the neighboring cell(s) (e.g., the NSAG(s) may be indicated by the NSAG information of the neighboring cell(s)) has the best match with the NSAG(s) that is received from the UE NAS 301, the UE 3 may reselect the neighboring cell(s) as the S-NSSAI(s) (service(s) associated with the S-NSSAI(s)) associated with the NSAG supported by the MN or the SN(s) regarding the neighboring cell(s) can be provisioned by the multi connectivity with the MN and SN(s) when a PDU session related to the S-NSSAI(s) is established.

For example, the UE AS 302 may perform the Network Slice Based Cell Reselection based on the broadcasted NSAG information regarding the SN(s).

The MN may obtain the NSAG information of the associated SN(s) from the local configuration or by the XnAP protocol as defined in NPL 6 and may broadcast the NSAG information of the associated SN(s). The NSAG information of the associated SN(s) may include supported NSAG(s) by the associated SN(s), NSAG priority related to the supported NSAG(s) and other related information.

For example, the SN may send, to the MN, the Xn Setup message, Xn Setup Response message, NG-RAN node Configuration Update message, NG-RAN node Configuration Update Acknowledge message, Mobility Change request message, Mobility Change Acknowledge message or any other existing or new XnAP messages including the supported NSAG(s) by the SN, NSAG priority related to the supported NSAG(s) and other related information.

### Variant 7 of First Example of the First Aspect

In one example, the AMF 70 sends an indicator which indicates to the UE 3 whether the NSAG procedure is applicable to the Pending NSSAI (or S-NSSAI(s) in the Pending NSSAI) or not in an existing NAS message or a new NAS message during the existing NAS procedure (for example in the Registration Accept message during initial registration procedure or periodic and mobility registration procedure). When the indicator indicates that the NSAG procedure is not applicable to S-NSSAI(s) in the Pending NSSAI, the UE NAS 301 does not send the S-NSSAI(s) in the Pending NSSAI (or NSAG related to the S-NSSAI(s) in the Pending NSSAI) to the UE AS 302 for Slice Based Cell Reselection procedure. For example, in a case where the indicator indicates that the NSAG procedure is not applicable to S-NSSAI #2 in the Pending NSSAI, the UE NAS 301 may not send at least one of the Pending NSSAI and NSAG #2 related to S-NSSAI #2 to the UE AS 302 in step 5 (or the UE NAS 301 may send at least one of NSAG #1 and the NSAG Priority related to NSAG #1 to the UE AS 302 in step 5). For example, in a case where the indicator indicates that the NSAG procedure is applicable to S-NSSAI #2 in the Pending NSSAI, the UE NAS 301 may send at least one of the Pending NSSAI and NSAG #2 related to S-NSSAI #2 to the UE AS 302 in step 5 (e.g., the UE NAS 301 may send at least one of NSAG #1, NSAG #2 and the NSAG Priority related to at least one of NSAG #1 and NSAG #2 to the UE AS 302 in step 5). For example, the UE AS 302 may use the Pending NSSAI in the same manner as the Variant 3 of First example of the First Aspect.

In one example the AMF 70 sends the indicator for each S-NSSAI in the Pending NSSAI. The UE 3 performs the NSAG procedure as the indicator of each S-NSSAI as defined above in this variant. For example, in a case where the Pending NSSAI includes S-NSSAI #4 and S-NSSAI #5, the indicator may indicate that the NSAG procedure is not applicable to S-NSSAI #4 and the NSAG procedure is applicable to S-NSSAI #5. The AMF 70 may configure the indicator based on the operator's policy or local configuration in the AMF 70 etc. In a case where the indicator indicates that the NSAG procedure is not applicable to S-NSSAI #4 and the NSAG procedure is applicable to S-NSSAI #5, the UE NAS 301 may send at least one of NSAG related to the S-NSSAI #5 and a NSAG Priority related to S-NSSAI #5 to the UE AS 302. Then the UE AS 302 may perform the Slice Based Cell Reselection procedure based on the at least one of NSAG related to the S-NSSAI #5 and a NSAG Priority related to S-NSSAI #5.

The above variants may be applied to Second example of the First Aspect.

According to the First example of the First Aspect and the variants of the First example of the First Aspect, it can solve the above-mentioned problem.

For example, the First example of the First Aspect and the variants of the First example of the First Aspect can solve the problem that there is some unclear situation(s) in the current 3GPP specifications.

For example, the First example of the First Aspect and the variants of the First example of the First Aspect can solve the problem that there is some unclear situation(s) regarding the Network Slice Based Cell Reselection feature and regarding the NSAG etc.

For example, the First example of the First Aspect and the variants of the First example of the First Aspect can solve the problem that it is not clear how the S-NSSAI(s) in the Pending NSSAI of the UE are to be used when the UE initiates the Network Slice Based Cell Reselection feature.

In addition, for example, the First example of the First Aspect and the variants of the First example of the First Aspect can solve the problem that it is not clear how the source RAN chooses candidate cell(s) for handover.

For example, the First example of the First Aspect and the variants of the First example of the First Aspect can solve the problem that it is not clear how the source RAN 5 chooses candidate cell(s) for handover by that the RAN chooses the candidate cell(s) taking the NSAG and the NSAG priority into account.

### Second Example of the First Aspect

A Second example of the First Aspect discloses a method where the UE NAS 301 selects NSAG and NSAG priority based on Allowed NSSAI for the Network Slice Based Cell Reselection in the first place although UE NAS 301 has a Pending NSSAI in the UE storage.

After all NSSAA procedure(s) has completed, then the UE NAS 301 reselects NSAG and NSAG priority based on Allowed NSSAI again if one or more S-NSSAIs from the Pending NSSAI were successful for the NSSAA procedure(s) and the UE NAS 301 sends the selected NSAG and NSAG priority to the AS layer of the UE (UE AS 302).

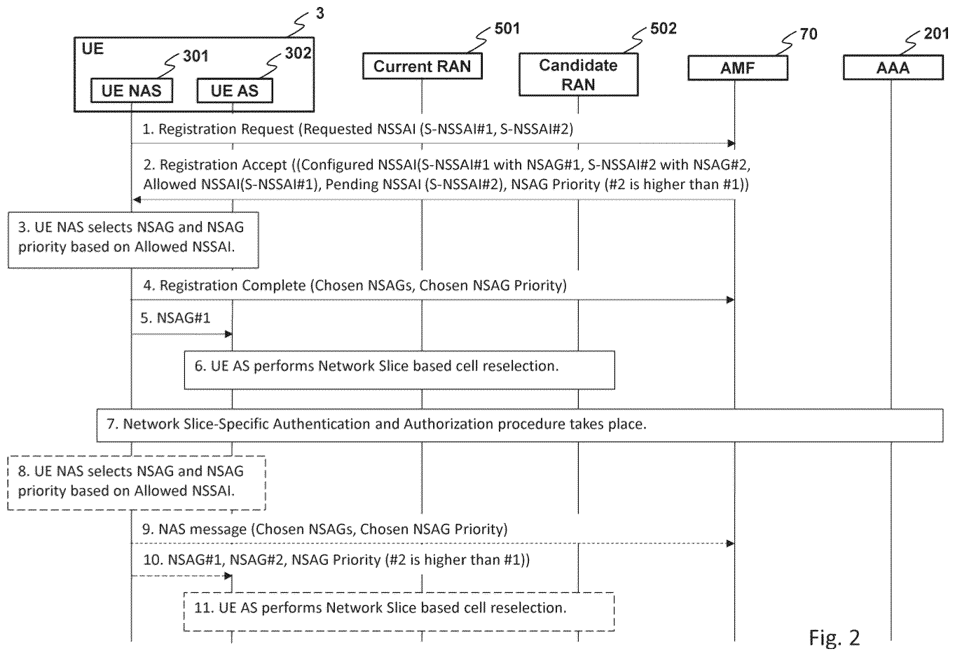

The detailed processes of the Second example of the First Aspect are described below, with reference to FIG. 2.

Step 1 and Step 2 are the same as step 1 and step 2 in the FIG. 1 for the First example of the First Aspect.

Step 3. Upon reception of a Registration Accept message in step 2, the UE NAS 301 selects a NSAG and a NSAG priority based on S-NSSAI(s) in the Allowed NSSAI. For example, the UE NAS 301 may select NSAG #1 as the NSAG. For example, the UE NAS 301 may select or decide that NSAG #2 has a higher priority than NSAG #1 as the NSAG priority. For example, the UE NAS 301 may select the NSAG and the NSAG priority based on S-NSSAI(s) in the Allowed NSSAI before the NSSAA procedure for S-NSSAI(s) in the Pending NSSAI completes. For example, the UE NAS 301 may select the NSAG and the NSAG priority based on S-NSSAI(s) in the Allowed NSSAI before the NSSAA procedure for S-NSSAI #2 in the Pending NSSAI completes. For example, the UE NAS 301 may select the NSAG and the NSAG priority based on S-NSSAI(s) in the Allowed NSSAI after the NSSAA procedure for S-NSSAI(s) in the Pending NSSAI completes successfully. For example, the UE NAS 301 may select the NSAG and the NSAG priority based on S-NSSAI(s) in the Allowed NSSAI after the NSSAA procedure for S-NSSAI #2 in the Pending NSSAI completes successfully.

Step 4 is the same as step 4 in the FIG. 1 for the First example of the First Aspect. For example, the UE NAS 301 may send the Registration Complete message to the AMF 70 including Chosen NSAGs and Chosen NSAG Priority.

The Chosen NSAGs includes the selected NSAG(s) in step 3. The Chosen NSAG Priority includes the NSAG priority decided in step 3.

For example, the Chosen NSAGs may include NSAG #1. For example, the Chosen NSAG Priority may include the NSAG priority indicating that NSAG #2 has a higher priority than NSAG #1.

The AMF 70 may perform same process(es) in the FIG. 1.

Step 5. The UE NAS 301 informs the selected NSAGs (e.g., NSAG #1) to the UE AS 302.

The NSAG priority may also be informed to the UE AS 302. For example, the NSAG priority may also be informed to the UE AS 302 although there is only one NSAG being informed.

Step 6. The UE AS 302 may perform Network Slice based cell reselection based on the selected NSAG (e.g., NSAG #1) that is received in step 5.

Step 7. The Network Slice-Specific Authentication and Authorization (NSSAA) procedure takes place for the S-NSSAI #2 between UE NAS 301 and an AAA 201. The step 7 may be performed after step 4 and before step 5. Further, the order of the step 7 and the set of step 4 and step 5 may be switched.

Step 8. After the NSSAA procedure has completed, the UE NAS 301 may reselect (or select) NSAG and NSAG priority based on Allowed NSSAI (e.g., at least one of S-NSSAI #1 and S-NSSAI #2) if the NSSAA procedure in step 7 is successful. If all NSSAA procedure(s) in step 7 have failed, the UE NAS 301 does not perform NSAG and NSAG priority selection again as there is no difference as an input for NSAG selection that is taken place at step 3. For example, the UE NAS 301 may select NSAG #1 and NSAG #2 as the NSAG. For example, the UE NAS 301 may select or decide that NSAG #2 has a higher priority than NSAG #1 as the NSAG priority. The Allowed NSSAI at step 8 may include at least S-NSSAI #2 as the NSSAA procedure for the S-NSSAI #2 has completed successfully. The Allowed NSSAI at step 8 may include at least S-NSSAI #1 and S-NSSAI #2 as the NSSAA procedure for the S-NSSAI #2 has completed successfully.

Step 9 is the same as step 9 in the FIG. 1 for the First example of the First Aspect. For example, the Chosen NSAGs may include NSAG #1 and NSAG #2. For example, the Chosen NSAG Priority may include the NSAG priority indicating that NSAG #2 has a higher priority than NSAG #1.

Step 10. The UE NAS 301 may inform the selected NSAGs (e.g., NSAG #1 and NSAG #2) and NSAG Priority (e.g., the NSAG priority indicating that NSAG #2 has a higher priority than NSAG #1) to the UE AS 302.

Step 11. The UE AS 302 may perform Network Slice based cell reselection based on the NSAGs (e.g., NSAG #1 and NSAG #2) and NSAG Priority (e.g., the NSAG priority indicating that NSAG #2 has a higher priority than NSAG #1) that are received in step 10.

### Variant 1 of Second Example of the First Aspect

In step 8, if the NSSAA procedure(s) is successfully performed for one or more S-NSSAI(s) and the UE NAS 301 is aware that newly added S-NSSAI(s) to the Allowed NSSAI are not supported by the current cell, the UE NAS 301 suppresses any services on the newly added S-NSSAI(s) until the Network Slice based cell reselection at step 11 is performed and the UE 3 confirms that new selected cell supports NSAGs for newly added S-NSSAI(s).

The UE NAS 301 may be aware that newly added S-NSSAI(s) to the Allowed NSSAI are not supported by the current cell based on information (e.g., system information) received from the current cell and information included in the Registration Accept message in step 2.

For example, it assumes that UE NAS 301 receives the Registration Accept message in step 2 and the UE 3 receives, from the current cell (e.g., the current RAN), the system information including information related NSAG #1 (e.g., the information indicates that the current cell supports NSAG #1 or supports S-NSSAI #1 associated with NSAG #1).

In this case, in a case where the NSSAA procedure for S-NSSAI #2 included in the Pending NSSAI is successfully performed, the UE 3 receives the Allowed NSSAI including at least the S-NSSAI #2.

In this case, the UE 3 is aware that the current cell does not support NSAG #2 or S-NSSAI #2 associated with NSAG #2 based on the system information.

Then the UE NAS 301 may suppress any services on S-NSSAI #2 until the Network Slice based cell reselection at step 11 is performed and the UE 3 confirms that new selected cell supports NSAGs for S-NSSAI #2. For example, the UE 3 may perform the Network Slice Based Cell Reselection to a cell that supports the NSAGs for S-NSSAI #2, then the UE 3 may start to use the service(s) on S-NSSAI #2.

According to the Second example of the First Aspect and the variants of the Second example of the First Aspect, it can solve the above-mentioned problem.

For example, the First example of the First Aspect and the variants of the First example of the First Aspect can solve the problem that there is some unclear situation(s) in the current 3GPP specifications.

For example, the Second example of the First Aspect and the variants of the Second example of the First Aspect can solve the problem that there is some unclear situation(s) regarding the Network Slice Based Cell Reselection feature and regarding the NSAG.

For example, the Second example of the First Aspect and the variants of the Second example of the First Aspect can solve the problem that it is not clear how the S-NSSAI(s) in the Pending NSSAI of the UE are to be used when the UE initiates the Network Slice Based Cell Reselection feature.

In addition, for example, the Second example of the First Aspect and the variants of the Second example of the First Aspect can solve the problem that it is not clear how the source RAN chooses candidate cell(s) for handover.

For example, the Second example of the First Aspect and the variants of the Second example of the First Aspect can solve the problem that it is not clear how the source RAN chooses candidate cell(s) for handover by that the RAN chooses the candidate cell(s) taking the NSAG and the NSAG priority into account.

### <Second Aspect>

When the NAS layer of the UE 3 (UE NAS 301) initiates the Network Slice Based Cell Reselection feature based on a new set of S-NSSAI(s), the new set of S-NSSAI(s) is included in the Requested NSSAI of the Registration Request message when the UE initiates the Registration Procedure after the Network Slice Based Cell Reselection.

This aspect discloses a method where the UE 3 triggers withdrawing of the S-NSSAI(s) from the Pending NSSAI within the network, e.g. AMF 70.

### First Example of the Second Aspect

A First example of the Second Aspect discloses a method for withdrawing S-NSSAI(s) in the Pending NSSAI by the UE 3.

If the NSSAA procedure is ongoing and the UE 3 is no longer interested in the S-NSSAI(s) in the Pending NSSAI, the UE NAS 301 sends the Registration Request message to the AMF 70 including S-NSSAI(s) in Withdrawing NSSAI.

The Withdrawing NSSAI indicates to the AMF 70 that the UE 3 is no longer interested in such S-NSSAI(s) in the Withdrawing NSSAI.

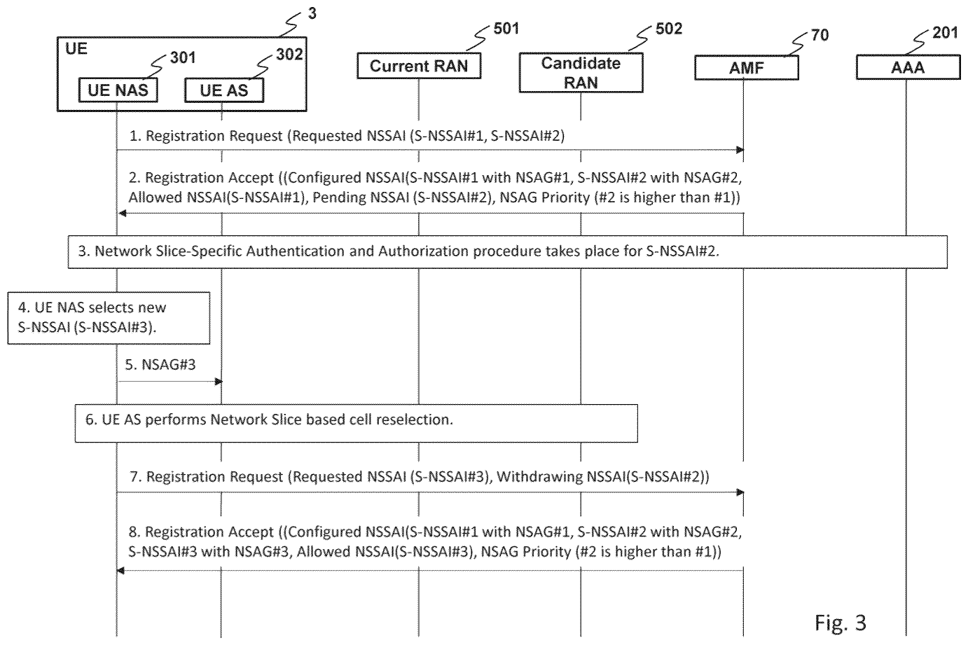

The detailed processes of the first example of the Second Aspect are described below, with reference to FIG. 3.

Step 1 and Step 2 are the same as step 1 and step 2 in the FIG. 1 for the First example of the First Aspect.

Step 3. The Network Slice-Specific Authentication and Authorization (NSSAA) procedure takes place for the S-NSSAI #2 in the Pending NSSAI between UE NAS 301 and an AAA 201.

Step 4. The UE NAS 301 selects a NSAG and a NSAG priority based on new set of the S-NSSAI(s). In this example, S-NSSAI #3 is referred as a new set of S-NSSAI(s). For example, an application in the UE 3 that is associated with S-NSSAI #3 is activated and user data are buffered in the UE 3 for to be sent to an associated application server in an external network. Then the UE NAS 301 may select the NSAG and the NSAG priority based on S-NSSAI #3. S-NSSAI #3 may be associated with NSAG #3. The UE NAS 301 may select the NSAG #3 and the NSAG priority for the NSAG #3. For example, the UE 3 may perform process(es) in step 4 while the UE 3 has the Pending NSSAI including S-NSSAI #2. For example, the UE 3 may perform process(es) in step 4 in a case where the NSSAA procedure for S-NSSAI #2 is ongoing.

Step 5. The UE NAS 301 informs the selected NSAGs (e.g., NSAG #3) to the UE AS 302.

The NSAG priority (e.g., the NSAG priority regarding NSAG #3) may also be informed to the UE AS 302 although there is only one NSAG being informed.

Step 6. The UE AS 302 may perform Network Slice based cell reselection based on the selected NSAG (e.g., NSAG #3) that is received in step 5.

Step 7. Upon completion of the Network Slice based cell reselection in step 6, the UE NAS 301 sends a Registration Request message to the AMF 70 including S-NSSAI #3 in the Requested NSSAI and S-NSSAI #2 in a Withdrawing NSSAI. For example, the UE NAS 301 may send the Registration Request message to the AMF 70 including S-NSSAI #3 in the Requested NSSAI and S-NSSAI #2 in a Withdrawing NSSAI in a case where the UE 3 has the Pending NSSAI including S-NSSAI #2 (or in a case where the NSSAA procedure for S-NSSAI #2 is ongoing). For example, the UE NAS 301 may perform process(es) in step 7 (e.g., the UE NAS 301 may send the Withdrawing NSSAI including S-NSSAI #2) to withdraw the Pending NSSAI including S-NSSAI #2 (or to release resources for the Pending NSSAI in the network).

For example, the UE NAS 301 may perform process(es) in step 7 (e.g., the UE NAS 301 may send the Withdrawing NSSAI including S-NSSAI #2) without waiting completion of the NSSAA procedure for S-NSSAI #2.

For example, according to current 3GPP standard(s), there is no way to indicate to withdraw the Pending NSSAI. For example, even if the UE 3 (or a user of the UE 3) is no longer interested in the Pending NSSAI (e.g., the UE 3 is interested in another service on S-NSSAI(s) which is different from S-NSSAI(s) in the Pending NSSAI), there is no way to indicate to withdraw the Pending NSSAI (or to indicate that the UE 3 is no longer interested in the Pending NSSAI).

Thus, resource(s) maintained for the Pending NSSAI that the UE 3 is not interested and the NSSAA procedure for the Pending NSSAI are meaningless or wasteful, and it may cause an inefficient network resource usage.

In addition, it assumes that a case where the UE 3 interested in S-NSSAI #3 and no longer interested in S-NSSAI #2 in the Pending NSSAI, and the S-NSSAI #2 and S-NSSAI #3 do not share at least one common NSSRG value.

In this case, there is possibility that the UE 3 cannot send the Requested NSSAI including S-NSSAI #3 even if the UE 3 is no longer interested in S-NSSAI #2 because the S-NSSAI #2 and S-NSSAI #3 do not share at least one common NSSRG value (or because the UE 3 may not determine whether the S-NSSAI #2 and S-NSSAI #3 share at least one common NSSRG value or determine contents of the Requested NSSAI, when S-NSSAI #2 is in the Pending NSSAI or before the NSSAA procedure for S-NSSAI #2 completes successfully).

Thus, it may may cause an unnecessary service degradation for all services that use S-NSSAI #3 as it causes a delay of service activation.

According to step 7 of this Aspect, the UE NAS 301 sends the Withdrawing NSSAI including S-NSSAI #2 to indicate to withdraw S-NSSAI #2 or the Pending NSSAI (or to indicate that the UE 3 is no longer interested in S-NSSAI #2 or the Pending NSSAI). In addition, the UE NAS 301 sends the Requested NSSAI including S-NSSAI #3.

For example, the UE NAS 301 may perform process(es) in step 7 (e.g., the UE NAS 301 may send the Withdrawing NSSAI including S-NSSAI #2) without checking whether the S-NSSAI(s) in the Withdrawing NSSAI and the S-NSSAI(s) in the Requested NSSAI in step 7 share at least one common NSSRG value (e.g., without checking whether S-NSSAI #2 and S-NSSAI #3 share at least one common NSSRG value).

The Withdrawing NSSAI contains one or more S-NSSAI(s) that is in the Pending NSSAI in the UE storage but the UE wishes to remove from the Pending NSSAI. The Withdrawing NSSAI may contain one or more S-NSSAI(s) that is in the Pending NSSAI in the UE storage but the UE is not interested in.

For example, the UE 3 may delete the Pending NSSAI after sending the Withdrawing NSSAI (or in a case where the UE 3 sends the Withdrawing NSSAI). For example, the UE 3 may abort the NSSAA procedure after sending the Withdrawing NSSAI (or in a case where the UE 3 sends the Withdrawing NSSAI). For example, the UE 3 may abort the NSSAA procedure for S-NSSAI #2 after sending the Withdrawing NSSAI (or in a case where the UE 3 sends the Withdrawing NSSAI). For example, in a case where the UE 3 sends the Withdrawing NSSAI including S-NSSAI #2, the UE 3 may delete the Pending NSSAI including S-NSSAI #2 or may remove S-NSSAI #2 from the Pending NSSAI. For example, the UE NAS 301 may send the Registration Request message including the Withdrawing NSSAI whenever the UE NAS 301 can send the Registration Request message. For example, the UE NAS 301 may send the Registration Request message including the Withdrawing NSSAI anytime. For example, the UE NAS 301 may send the Registration Request message including the Withdrawing NSSAI whenever the UE 3 has the Pending NSSAI.

When the AMF 70 receives the Registration Request message including the Withdrawing NSSAI, the AMF 70 aborts the NSSAA procedure for S-NSSAI(s) that is set in the Withdrawing NSSAI.

For example, it assumes a case where the Withdrawing NSSAI includes S-NSSAI #2. In this case, the AMF 70 may abort the NSSAA procedure for S-NSSAI #2.

For example, it assumes that AMF 70 receives the Registration Request message including the Withdrawing NSSAI and the Withdrawing NSSAI includes S-NSSAI #2. In this case, the AMF 70 may abort the NSSAA procedure for S-NSSAI #2 in a case where the NSSAA procedure for S-NSSAI #2 is ongoing. In this case, the AMF 70 may abort the NSSAA procedure for S-NSSAI #2 in a case where the AMF 70 determines that the NSSAA procedure for S-NSSAI #2 is ongoing.

If the AMF 70 receives the Registration Request message including the Withdrawing NSSAI and the NSSAA procedure has just successfully completed for S-NSSAI(s) that is set in the Withdrawing NSSAI, then the AMF 70 removes the S-NSSAI(s) from the Allowed NSSAI.

For example, it assumes a case where the Withdrawing NSSAI includes S-NSSAI #2 and the NSSAA procedure has just successfully completed for S-NSSAI #2 (or a case where the AMF 70 receives the Withdrawing NSSAI including S-NSSAI #2 and the NSSAA procedure has successfully completed for S-NSSAI #2 when the AMF receives the Withdrawing NSSAI). In this case, the AMF 70 may remove S-NSSAI #2 from the Allowed NSSAI in the AMF 70 or the AMF 70 may not add S-NSSAI #2 to the Allowed NSSAI in the AMF 70. For example, the AMF 70 may send the Allowed NSSAI without S-NSSAI #2 to the UE 3 and the UE 3 may update the Allowed NSSAI in the UE 3 based on the received Allowed NSSAI without S-NSSAI #2.

If the AMF 70 receives the Registration Request message including the Withdrawing NSSAI and the NSSAA procedure has just completed with failure for S-NSSAI(s) that is set in the Withdrawing NSSAI, then the AMF 70 keeps the S-NSSAI(s) in Rejected NSSAI (e.g., the AMF 70 may include the S-NSSAI(s) to the Rejected NSSAI or move the S-NSSAI(s) from the Pending NSSAI to the Rejected NSSAI) or maintain the status of the NSSAA procedure of the Withdrawing NSSAI. For example, the AMF 70 may send the Rejected NSSAI to the UE 3.

For example, it assumes a case where the Withdrawing NSSAI includes S-NSSAI #2 and the NSSAA procedure for S-NSSAI #2 has failed. In this case, the AMF 70 may keep S-NSSAI #2 in the Rejected NSSAI or maintain the status of the NSSAA procedure of the Withdrawing NSSAI (e.g., the AMF 70 may maintain information indicating that the NSSAA procedure for S-NSSAI #2 has failed as the status).

The UE 3 does not consider S-NSSAI(s) in the Withdrawing NSSAI for the NSSRG procedure i.e. the UE 3 does not check whether the S-NSSAI(s) in Withdrawing NSSAI shares at least one common NSSRG value (or at least one common NSSRG group) with the S-NSSAI(s) in Requested NSSAI in the Registration Request message. The UE 3 may check whether the S-NSSAI(s) in Withdrawing NSSAI shares at least one common NSSRG value with the S-NSSAI(s) in Requested NSSAI in the Registration Request message.

The Withdrawing NSSAI may be expressed by another way. For example, the Withdrawing NSSAI may be expressed as abandon NSSAI, Abandoning NSSAI, Unrequested NSSAI or any other notation for NSSAI which contains one or more S-NSSAI(s) that is part of the Pending NSSAI however, the UE 3 is no more interested in. For example, the Withdrawing NSSAI may be expressed as any other notation for NSSAI which contains one or more S-NSSAI(s) that is not to be added to the Allowed NSSAI for the UE 3 after successful NSSAA procedure on the S-NSSAI(s).

Step 8. The AMF 70 sends a Registration Accept message to the UE NAS 301 including the Configured NSSAI, Allowed NSSAI, Pending NSSAI and NSAG Priority.

The Configured NSSAI includes the S-NSSAI #1 with the associated NSAG #1, the S-NSSAI #2 with the associated NSAG #2 and the S-NSSAI #3 with the associated NSAG #3.

Here, NSAG information in the Registration Accept message may include the relationship between S-NSSAI and NSAG (i.e. the S-NSSAI #1 with the associated NSAG #1, the S-NSSAI #2 with the associated NSAG #2 and the S-NSSAI #3 with the associated NSAG #3).

The Allowed NSSAI includes the S-NSSAI #3.

The NSAG Priority indicates a priority order among the NSAGs.

After successful Registration procedure by Step 7 and Step 8, the UE 3 can have the S-NSSAI #3 only in the Allowed NSSAI in the storage of the UE 3.

For example, in a case where the UE 3 receives the Registration Accept message, the UE 3 may delete the Pending NSSAI. For example, in a case where the UE 3 receives the Registration Accept message, the UE 3 may delete the Pending NSSAI including S-NSSAI #2 or may remove S-NSSAI #2 from the Pending NSSAI.

For example, the AMF 70 may send a request to delete the Pending NSSAI or remove, from the Pending NSSAI, S-NSSAI(s) which is included in the Withdrawing NSSAI. For example, the AMF 70 may send the request in a case where the AMF 70 receives the Withdrawing NSSAI from the UE 3. The request may be included in the Registration Accept message or any other NAS messages. In a case where the UE 3 receives the request to delete the Pending NSSAI including S-NSSAI #2 or to remove S-NSSAI #2 from the Pending NSSAI, the UE 3 may delete the Pending NSSAI or may remove S-NSSAI #2 from the Pending NSSAI.

The AMF 70 does not check S-NSSAI(s) in the Withdrawing NSSAI when the AMF 70 applies NSSRG procedure on the Allowed NSSAI. I.e. the AMF 70 doesn't check whether S-NSSAI(s) in the Withdrawing NSSAI shares at least one common NSSRG group (or at least one common NSSRG value) with the S-NSSAI(s) in the Allowed NSSAI. For example, the AMF 70 may not consider the NSSRG value for S-NSSAI(s) in the Withdrawing NSSAI to determine the contents of the Allowed NSSAI (i.e., S-NSSAI(s) in the Allowed NSSAI of the Registration Request message in step 8 and S-NSSAI(s) in the Withdrawing NSSAI may share or may not share at least one common NSSRG value).

If the AMF 70 has successfully incremented the number of UE count by executing NumOfUEsUpdate service operation for the S-NSSAI(s) in the Withdrawing NSSAI (e.g., if the AMF 70 has successfully incremented the number of UE count by executing NumOfUEsUpdate service operation for the S-NSSAI #2), then the AMF 70 may initiate NumOfUEsUpdate service operation for each S-NSSAI(s) in the Withdrawing NSSAI to decrement the number of UE count in the NSACF (e.g., the AMF 70 may initiate NumOfUEsUpdate service operation for S-NSSAI #2 to decrement the number of UE count in the NSACF).

### Variant 1 of First Example of the Second Aspect

In one example, the Withdrawing NSSAI can be sent from the UE 3 to the AMF 70 by another NAS message such as Registration complete message, Identity Response message, Authentication response message, UL NAS TRANSPORT message, De-registration request message, Configuration update complete message, Network slice-specific authentication complete message or any other existing NAS message or a new NAS message defined for to withdraw the Pending NSSAI. In this case the AMF 70 sends response in an any existing NAS message or in a new NAS message. For example, the UE NAS 301 may send the above message including the Withdrawing NSSAI whenever the UE NAS 301 can send the above message. For example, the UE NAS 301 may send the above message including the Withdrawing NSSAI anytime. For example, the UE NAS 301 may send the above message including the Withdrawing NSSAI whenever the UE 3 has the Pending NSSAI.

### Variant 2 of First Example of the Second Aspect

In one another example, in step 7, instead indicating in the Withdrawing NSSAI the S-NSSAI(s) from the Pending NSSAI that the UE 3 is no more interested in, the UE 3 may make use of a new parameter in the NAS message to the AMF 70 called for example ‘pending off’ or any other notation for a parameter in order to indicate to the AMF 70 that the UE 3 is no more interested in the S-NSSAI(s) from the Pending NSSAI so that the AMF 70 does not include the S-NSSAI(s) in the Allowed NSSAI for the UE in a case where the NSSAA procedure for the S-NSSAI(s) is successful. This use case is applicable when the UE 3 is no more interested in all the S-NSSAI(s) from the Pending NSSAI. That is why in such a case the UE 3 may make use of a single flag within the NAS message to the AMF 70 instead listing all the S-NSSAI(s) from the Pending NSSAI within the Withdrawing NSSAI.

For example, the AMF 70 may perform same process(es) in step 7 in a case where the AMF 70 receives the ‘pending off’ parameter.

For example, the AMF 70 may abort the NSSAA procedure for at least one S-NSSAI(s) in the Pending NSSAI in a case where the AMF 70 receives the ‘pending off’ parameter.

For example, in a case where the AMF 70 receives the ‘pending off’ parameter and the NSSAA procedure has successfully completed for the S-NSSAI(s) in the Pending NSSAI, the AMF 70 may remove the S-NSSAI(s) from the Allowed NSSAI.

For example, in a case where the AMF 70 receives the ‘pending off’ parameter and the NSSAA procedure has failed for the S-NSSAI(s) in the Pending NSSAI, the AMF 70 may keep the S-NSSAI(s) in Rejected NSSAI (e.g., the AMF 70 may include the S-NSSAI(s) to the Rejected NSSAI or move the S-NSSAI(s) from the Pending NSSAI to the Rejected NSSAI) or maintain the status of the NSSAA procedure for the S-NSSAI(s).

### Variant 3 of First Example of the Second Aspect

In one example, the AMF 70 sends an indicator which indicates to the UE 3 whether the NSSRG procedure is applicable to the Pending NSSAI or not in an existing NAS message or a new NAS message during the existing NAS procedure (for example in the Registration Accept message during initial registration procedure or periodic and mobility registration procedure). When the indicator indicates that the NSSRG procedure is not applicable to S-NSSAI(s) in the Pending NSSAI, the UE NAS 301 does not check the S-NSSAI(s) in the Pending NSSAI whether the S-NSSAI(s) in the Pending NSSAI share common NSSRG value with S-NSSAI(s) in Requested NSSAI or Allowed NSSAI i.e. does not check whether to apply the NSSRG procedure to the S-NSSAI(s) in the Pending NSSAI and the S-NSSAI(s) in the Requested NSSAI or the Allowed NSSAI. If the indicator indicates that the NSSRG procedure is applicable to the Pending NSSAI, then the UE NAS 301 applies the NSSRG procedure to the S-NSSAI(s) of the Pending NSSAI as well i.e. the UE 3 checks if the S-NSSAI(s) in the Requested NSSAI or Allowed NSSAI and S-NSSAI(s) in the Pending NSSAI share at least one common NSSRG value. The indicator may indicate the NSSRG procedure is applicable for each S-NSSAI in the Pending NSSAI.

In a case where the indicator indicates that the NSSRG procedure is not applicable to S-NSSAI #2 in the Pending NSSAI, the UE NAS 301 may not check whether S-NSSAI #2 and S-NSSAI(s) in the Requested NSSAI or in the Allowed NSSAI share at least one common NSSRG value.

For example, in this case, the UE NAS 301 may include, in any NAS message, S-NSSAI #2 and the S-NSSAI(s) of the Requested NSSAI or of the Allowed NSSAI, even if S-NSSAI #2 and the S-NSSAI(s) of the Requested NSSAI or of the Allowed NSSAI do not share the at least one common NSSRG value.

The Withdrawing NSSAI may include at least one of S-NSSAI(s) of the Pending NSSAI.

In addition, in a case where the indicator indicates that the NSSRG procedure is not applicable to S-NSSAI #2 in the Pending NSSAI and the UE NAS 301 wants to include S-NSSAI #2 to the Withdrawing NSSAI (e.g., the UE 3 is no longer interested in S-NSSAI #2 in the Pending NSSAI), the UE NAS 301 may not check whether S-NSSAI #2 and S-NSSAI(s) in the Requested NSSAI or in the Allowed NSSAI share at least one common NSSRG value.

Hence, in a case where the indicator indicates that the NSSRG procedure is not applicable to S-NSSAI #2 in the Pending NSSAI, in step 7, the UE NAS 301 may send the Registration Request message including the Requested NSSAI which includes S-NSSAI #3 and the Withdrawing NSSAI which includes S-NSSAI #2, even if S-NSSAI #2 and S-NSSAI #3 do not share the at least one common NSSRG value.

### Variant 4 of First Example of the Second Aspect

In step 2 or 8, the AMF 70 may include combinations of NSAG(s) (e.g., NSAG(s) related to neighbouring TA(s)) and TAC of neighbouring TA(s) that is located outside the current Registration Area (RA) in the Registration Accept message if neighbouring TA(s) configures NSAG(s) per TA(s) for S-NSSAI(s) in the Configured NSSAI. For example, the AMF 70 may include, in the Registration Accept message or any NAS messages, combination(s) of TAC(s) of neighbouring TA(s) that is located outside of the current RA and NSAG(s) related to the neighbouring TA(s). The AMF 70 may send the Registration Accept message or the any NAS messages to the UE NAS 301. The combination(s) may be expressed as NSAG information of the neighbouring TA(s) or NSAG information of the neighbouring TA(s) outside of the current RA or NSAG information for the TA(s) that is not within the RA but located to close to the RA. The AMF 70 may obtain the combination(s) from other network nodes (e.g., another AMF). The AMF 70 may store the combination(s). The AMF 70 may determine the combination(s) based on the local configuration or operator's policy. The NSAG information of the neighbouring TA(s) may include NSAG priority which is related to the NSAG(s) related to neighbouring TA(s).

I.e., the AMF 70 may include, in the Registration Accept message, NSAG information (e.g., NSAG(s)) for the TA(s) that is not within the RA but located to close to the RA and the NSAG(s) may be associated with the TA(s). The NSAG information of the neighbouring TA(s) outside of the current RA is used by the UE 3 to select or reselect a cell based on the Network Slice Based Cell Reselection feature when the UE 3 moves out from the RA. For example, the UE NAS 301 may send the NSAG information of the neighbouring TA(s) to the UE AS 302, and the UE AS 302 may use the NSAG information of the neighbouring TA(s) to select or reselect a cell based on the Network Slice Based Cell Reselection feature.

When the UE 3 is moving out from the current RA and the UE 3 (e.g., the UE AS 302) can scan candidate cell(s) that transmits or broadcasts NSAG(s) and associated TAC over the SIB (e.g., SIB16) and/or dedicated signaling, then the UE AS 302 may check whether the broadcasted NSAG and associated TAC match with the NSAG(s) and NSAG priority that are provided by the UE NAS 301. If at least one of the NSAG(s) and NSAG priority matches, the UE 3 may tune to that cell (e.g., the UE AS 302 may select or reselect that cell) and may initiate the Registration Procedure (e.g., the UE NAS 301 may initiate the Registration Procedure in that cell).

For example, the UE 3 may determine that the UE 3 can scan candidate cell(s) that transmits or broadcasts NSAG(s) and associated TAC based on the NSAG information of the neighbouring TA(s). For example, the UE 3 may scan the candidate cell(s) that transmits or broadcasts the NSAG(s) and the TAC(s) indicated by the NSAG information of the neighbouring TA(s).

If the NSAG and NSAG priority does not match, the UE 3 select a cell based on an existing cell selection mechanism and initiates the Registration Procedure.

The above variants may be applied to the First Aspect.

According to the First example of the Second Aspect and the variants of the First example of the Second Aspect, it can solve the above-mentioned problem.

For example, the First example of the First Aspect and the variants of the First example of the First Aspect can solve the problem that there is some unclear situation(s) in the current 3GPP specifications.

For example, the First example of the Second Aspect and the variants of the First example of the Second Aspect can solve the problem that there is some unclear situation(s) regarding the Network Slice Based Cell Reselection feature and regarding the NSAG etc.

For example, the First example of the Second Aspect and the variants of the First example of the Second Aspect can solve the problem that the NSSAA procedure for the S-NSSAI(s) of the Pending NSSAI that the UE is no longer interested may be meaningless.

For example, the First example of the Second Aspect and the variants of the First example of the Second Aspect can solve the problem that the NSSAA procedure for the S-NSSAI(s) of the Pending NSSAI that the UE is no longer interested may cause to put loads on the network.

For example, the First example of the Second Aspect and the variants of the First example of the Second Aspect can solve the problem that the NSSAA procedure for the S-NSSAI(s) of the Pending NSSAI that the UE is no longer interested may cause an inefficient network resource usage. For example, the First example of the Second Aspect and the variants of the First example of the Second Aspect can solve the problem that Network resources for the S-NSSAI(s) of the Pending NSSAI may be maintained unnecessary in the network without use.

For example, the First example of the Second Aspect and the variants of the First example of the Second Aspect can solve the problem that may cause a delay of service activation and may cause an unnecessary service degradation for all services that use the new set of S-NSSAI(s).

For example, the First example of the Second Aspect and the variants of the First example of the Second Aspect can solve the problem that may cause an unnecessary service termination for all services that use the S-NSSAI(s) in the Allowed NSSAI as the UE cannot select a suitable cell for the S-NSSAI(s) in the Allowed NSSAI based on the Network Slice Based Cell Reselection feature when the UE traverses the RA boundary.

### <System Overview>

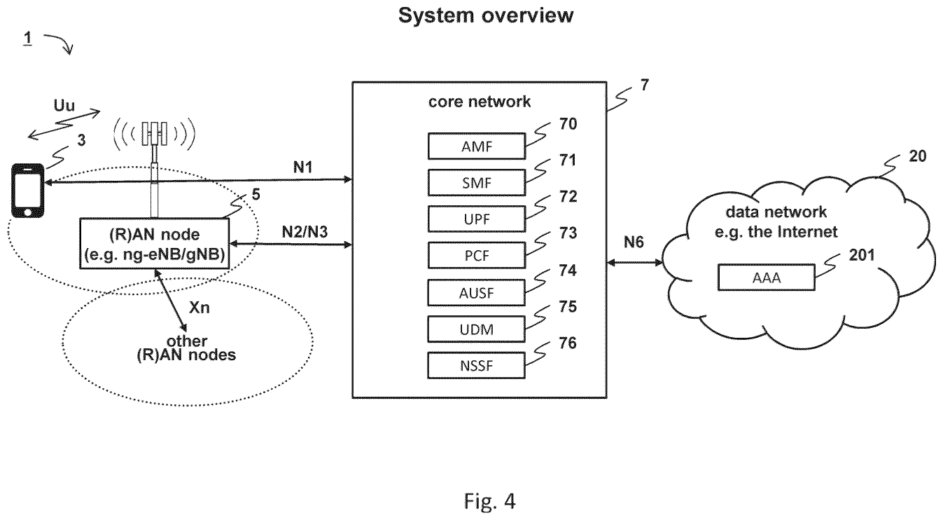

FIG. 4 schematically illustrates a telecommunication system 1 for a mobile (cellular or wireless) to which the above aspects are applicable.

The telecommunication system 1 represents a system overview in which an end to end communication is possible. For example, UE 3 (or user equipment, ‘mobile device’ 3) communicates with other UEs 3 or service servers in the data network 20 via respective (R)AN nodes 5 and a core network 7.

The (R)AN node 5 supports any radio accesses including a 5G radio access technology (RAT), an E-UTRA radio access technology, a beyond 5G RAT, a 6G RAT and non-3GPP RAT including wireless local area network (WLAN) technology as defined by the Institute of Electrical and Electronics Engineers (IEEE).

The (R)AN node 5 may split into a Radio Unit (RU), Distributed Unit (DU) and Centralized Unit (CU). In some aspects, each of the units may be connected to each other and structure the (R)AN node 5 by adopting an architecture as defined by the Open RAN (O-RAN) Alliance, where the units above are referred to as O-RU, O-DU and O-CU respectively.

The (R)AN node 5 may be split into control plane function and user plane function. Further, multiple user plane functions can be allocated to support a communication. In some aspects, user traffic may be distributed to multiple user plane functions and user traffic over each user plane functions are aggregated in both the UE 3 and the (R)AN node 5. This split architecture may be called as ‘dual connectivity’ or ‘Multi connectivity’.

The (R)AN node 5 can also support a communication using the satellite access. In some aspects, the (R)AN node 5 may support a satellite access and a terrestrial access.

In addition, the (R)AN node 5 can also be referred as an access node for a non-wireless access. The non-wireless access includes a fixed line access as defined by the Broadband Forum (BBF) and an optical access as defined by the Innovative Optical and Wireless Network (IOWN).

The core network 7 may include logical nodes (or ‘functions’) for supporting a communication in the telecommunication system 1. For example, the core network 7 may be 5G Core Network (5GC) that includes, amongst other functions, control plane functions and user plane functions. Each function in a logical nodes can be considered as a network function. The network function may be provided to another node by adapting the Service Based Architecture (SBA).

A Network Function can be deployed as distributed, redundant, stateless, and scalable that provides the services from several locations and several execution instances in each location by adapting the network virtualization technology as defined by the European Telecommunications Standards Institute, Network Functions Virtualization (ETSI NFV).

The core network 7 may support the Non-Public Network (NPN). The NPN may be a Stand-alone Non-Public Network (SNPN) or a Public Network Integrated NPN (PNI-NPN).

As is well known, a UE 3 may enter and leave the areas (i.e. radio cells) served by the (R)AN node 5 as the UE 3 is moving around in the geographical area covered by the telecommunication system 1. In order to keep track of the UE 3 and to facilitate movement between the different (R)AN nodes 5, the core network 7 comprises at least one access and mobility management function (AMF) 70. The AMF 70 is in communication with the (R)AN node 5 coupled to the core network 7. In some core networks, a mobility management entity (MME) or a mobility management node for beyond 5G or a mobility management node for 6G may be used instead of the AMF 70.

The core network 7 also includes, amongst others, a Session Management Function (SMF) 71, a User Plane Function (UPF) 72, a Policy Control Function (PCF) 73, an Authentication Server Function (AUSF) 74, a Unified Data Management (UDM) 75, and a Network Slice Selection Function (NSSF) 76.

When the UE 3 is roaming to a visited Public Land Mobile Network (VPLMN), a home Public Land Mobile Network (HPLMN) of the UE 3 provides the UDM 75 and at least some of the functionalities of the SMF 71, UPF 72, and PCF 73 for the roaming-out UE 3.

The UE 3 and a respective serving (R)AN node 5 are connected via an appropriate air interface (for example the so-called “Uu” interface and/or the like). Neighboring (R)AN node 5 are connected to each other via an appropriate (R)AN node 5 to (R)AN node interface (such as the so-called “Xn” interface and/or the like). Each (R)AN node 5 is also connected to nodes in the core network 7 (such as the so-called core network nodes) via an appropriate interface (such as the so-called “N2”/“N3” interface(s) and/or the like). From the core network 7, connection to a data network 20 is also provided. The data network 20 can be an internet, a public network, an external network, a private network or an internal network of the PLMN. In case that the data network 20 is provided by a PLMN operator or Mobile Virtual Network Operator (MVNO), the IP Multimedia Subsystem (IMS) service may be provided by that data network 20. The UE 3 can be connected to the data network 20 using IPv4, IPv6, IPv4v6, Ethernet or unstructured data type. The data network may include an AAA 201.

The “Uu” interface may include a Control plane of Uu interface and User plane of Uu interface.

The User plane of Uu interface is responsible to convey user traffic between the UE 3 and a serving (R)AN node 5. The User plane of Uu interface may have a layered structure with SDAP, PDCP, RLC and MAC sublayer over the physical connection.

The Control plane of Uu interface is responsible to establish, modify and release a connection between the UE 3 and a serving (R)AN node 5. The Control plane of Uu interface may have a layered structure with RRC, PDCP, RLC and MAC sublayers over the physical connection.

For example, the following messages are communicated over the RRC layer to support AS signaling.
RRC Setup Request message: This message is sent from the UE 3 to the (R)AN node 5. In addition to the parameters that are disclosed by Aspects in this disclosure, following parameters may be included together in the RRC Setup Request message.
   establishmentCause and ue-Identity. The ue-Identity may have a value of ng-5G-S-TMSI-Part1 or random Value.
RRC Setup message: This message is sent from the (R)AN node 5 to the UE 3. In addition to the parameters that are disclosed by Aspects in this disclosure, following parameters may be included together in the RRC Setup message.
   masterCellGroup and radioBearerConfig.
RRC setup complete message: This message is sent from the UE 3 to the (R)AN node 5. In addition to the parameters that are disclosed by Aspects in this disclosure, following parameters may be included together in the RRC setup complete message.
   guami-Type, iab-NodeIndication, idleMeas Available, mobility State, ng-5G-S-TMSI-Part2, registeredAMF, selectedPLMN-Identity.

The UE 3 and the AMF 70 are connected via an appropriate interface (for example the so-called N1 interface and/or the like). The N1 interface is responsible to provide a communication between the UE 3 and the AMF 70 to support NAS signaling. The N1 interface may be established over a 3GPP access and over a non-3GPP access. For example, the following messages are communicated over the N1 interface.
registration request message: This message is sent from the UE 3 to the AMF 70. In addition to the parameters that are disclosed by Aspects in this disclosure, following parameters may be included together in the registration request message.
   5GS registration type, ngKSI, 5GS mobile identity, Non-current native NAS key set identifier, 5GMM capability, UE security capability, Requested NSSAI, Last visited registered TAI, S1 UE network capability, Uplink data status, PDU session status, MICO indication, UE status, Additional GUTI, Allowed PDU session status, UE's usage setting, Requested DRX parameters, EPS NAS message container, LADN indication, Payload container type, Payload container, Network slicing indication, 5GS update type, Mobile station classmark 2, Supported codecs, NAS message container, EPS bearer context status, Requested extended DRX parameters, T3324 value, UE radio capability ID, Requested mapped NSSAI, Additional information requested, Requested WUS assistance information, N5GC indication and Requested NB-N1 mode DRX parameters.
registration accept message: This message is sent from the AMF 70 to the UE 3. In addition to the parameters that are disclosed by Aspects in this disclosure, following parameters may be included together in the registration accept message.
   5GS registration result, 5G-GUTI, Equivalent PLMNs, TAI list, Allowed NSSAI, Rejected NSSAI, Configured NSSAI, 5GS network feature support, PDU session status, PDU session reactivation result, PDU session reactivation result error cause, LADN information, MICO indication, Network slicing indication, Service area list, T3512 value, Non-3GPP de-registration timer value, T3502 value, Emergency number list, Extended emergency number list, SOR transparent container, EAP message, NSSAI inclusion mode, Operator-defined access category definitions, Negotiated DRX parameters, Non-3GPP NW policies, EPS bearer context status, Negotiated extended DRX parameters, T3447 value, T3448 value, T3324 value, UE radio capability ID, UE radio capability ID deletion indication, Pending NSSAI, Ciphering key data, CAG information list, Truncated 5G-S-TMSI configuration, Negotiated WUS assistance information, Negotiated NB-N1 mode DRX parameters and Extended rejected NSSAI.
Registration Complete message: This message is sent from the UE 3 to the AMF 70. In addition to the parameters that are disclosed by Aspects in this disclosure, following parameters may be included together in the Registration Complete message.
   SOR transparent container.
Authentication Request message: This message is sent from the AMF 70 to the UE 3. In addition to the parameters that are disclosed by Aspects in this disclosure, following parameters may be included together in the Authentication Request message.
   ngKSI, ABBA, Authentication parameter RAND (5G authentication challenge), Authentication parameter AUTN (5G authentication challenge) and EAP message.
Authentication Response message: This message is sent from the UE 3 to the AMF 70. In addition to the parameters that are disclosed by Aspects in this disclosure, following parameters may be populated together in the Authentication Response message.
   Authentication response message identity, Authentication response parameter and EAP message.
Authentication Result message: This message is sent from the AMF 70 to the UE 3. In addition to the parameters that are disclosed by Aspects in this disclosure, following parameters may be populated together in the Authentication Result message.
   ngKSI, EAP message and ABBA.
Authentication Failure message: This message is sent from the UE 3 to the AMF 70. In addition to the parameters that are disclosed by Aspects in this disclosure, following parameters may be populated together in the Authentication Failure message.
   Authentication failure message identity, 5GMM cause and Authentication failure parameter.
Authentication Reject message: This message is sent from the AMF 70 to the UE 3. In addition to the parameters that are disclosed by Aspects in this disclosure, following parameters may be populated together in the Authentication Reject message.
   EAP message.
Service Request message: This message is sent from the UE 3 to the AMF 70. In addition to the parameters that are disclosed by Aspects in this disclosure, following parameters may be populated together in the Service Request message.
   ngKSI, Service type, 5G-S-TMSI, Uplink data status, PDU session status, Allowed PDU session status, NAS message container.
Service Accept message: This message is sent from the AMF 70 to the UE 3. In addition to the parameters that are disclosed by Aspects in this disclosure, following parameters may be populated together in the Service Accept message.
   PDU session status, PDU session reactivation result, PDU session reactivation result error cause, EAP message and T3448 value.
Service Reject message: This message is sent from the AMF 70 to the UE 3. In addition to the parameters that are disclosed by Aspects in this disclosure, following parameters may be populated together in the Service Reject message.
   5GMM cause, PDU session status, T3346 value, EAP message, T3448 value and CAG information list.
Configuration Update Command message: This message is sent from the AMF 70 to the UE 3. In addition to the parameters that are disclosed by Aspects in this disclosure, following parameters may be populated together in the Configuration Update Command message.
   Configuration update indication, 5G-GUTI, TAI list, Allowed NSSAI, Service area list, Full name for network, Short name for network, Local time zone, Universal time and local time zone, Network daylight saving time, LADN information, MICO indication, Network slicing indication, Configured NSSAI, Rejected NSSAI, Operator-defined access category definitions, SMS indication, T3447 value, CAG information list, UE radio capability ID, UE radio capability ID deletion indication, 5GS registration result, Truncated 5G-S-TMSI configuration, Additional configuration indication and Extended rejected NSSAI.
Configuration Update Complete message: This message is sent from the UE 3 to the AMF 70. In addition to the parameters that are disclosed by Aspects in this disclosure, following parameters may be populated together in the Configuration Update Complete message.
   Configuration update complete message identity.

### User Equipment (UE)

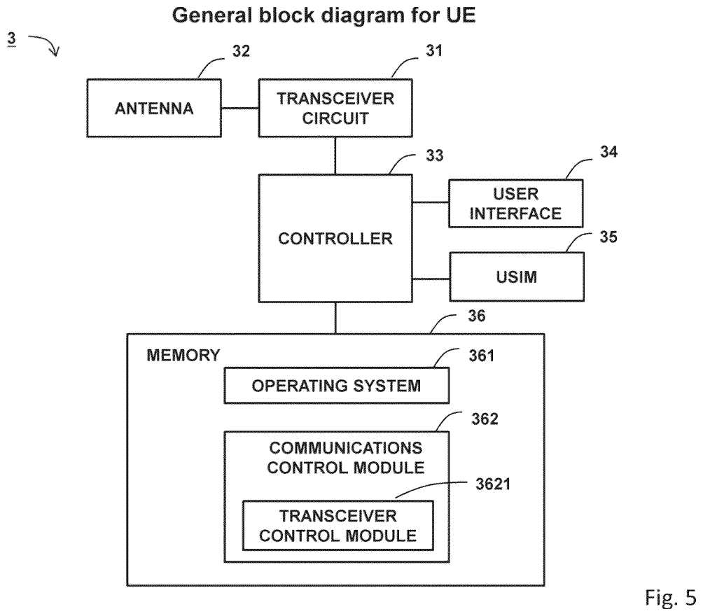

FIG. 5 is a block diagram illustrating the main components of the UE 3 (mobile device 3). As shown, the UE 3 includes a transceiver circuit 31 which is operable to transmit signals to and to receive signals from the connected node(s) via one or more antennas 32. Further, the UE 3 may include a user interface 34 for inputting information from outside or outputting information to outside. Although not necessarily shown in the FIG. 5, the UE 3 may have all the usual functionality of a conventional mobile device and this may be provided by any one or any combination of hardware, software and firmware, as appropriate. Software may be pre-installed in the memory and/or may be downloaded via the telecommunication network or from a removable data storage device (RMD), for example. A controller 33 controls the operation of the UE 3 in accordance with software stored in a memory 36. The software includes, among other things, an operating system 361 and a communications control module 362 having at least a transceiver control module 3621. The communications control module 362 (using its transceiver control module 3621) is responsible for handling (generating/sending/receiving) signalling and uplink/downlink data packets between the UE 3 and other nodes, such as the (R)AN node 5 and the AMF 70. Such signalling may include, for example, appropriately formatted signalling messages (e.g. a registration request message and associated response messages) relating to access and mobility management procedures (for the UE 3). The controller 33 interworks with one or more Universal Subscriber Identity Module (USIM) 35. If there are multiple USIMs 35 equipped, the controller 33 may activate only one USIM 35 or may activate multiple USIMs 35 at the same time.

The UE 3 may, for example, support the Non-Public Network (NPN), The NPN may be a Stand-alone Non-Public Network (SNPN) or a Public Network Integrated NPN (PNI-NPN).

The UE 3 may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

The UE 3 may, for example, be an item of transport equipment (for example transport equipment such as: rolling stocks; motor vehicles; motor cycles; bicycles; trains; buses; carts; rickshaws; ships and other watercraft; aircraft; rockets; satellites; drones; balloons etc.).

The UE 3 may, for example, be an item of information and communication equipment (for example information and communication equipment such as: electronic computer and related equipment; communication and related equipment; electronic components etc.).

The UE 3 may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

the UE 3 may, for example, be an electrical application system or equipment (for example an electrical application system or equipment such as: an x-ray system; a particle accelerator; radio isotope equipment; sonic equipment; electromagnetic application equipment; electronic power application equipment etc.).

The UE 3 may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

The UE 3 may, for example, be a wireless-equipped personal digital assistant or related equipment (such as a wireless card or module designed for attachment to or for insertion into another electronic device (for example a personal computer, electrical measuring machine)).

The UE 3 may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices or Narrow Band-IoT UE (NB-IoT UE). It will be appreciated that a UE 3 may support one or more IoT or MTC applications.

The UE 3 may be a smart phone or a wearable device (e.g. smart glasses, a smart watch, a smart ring, or a hearable device).

The UE 3 may be a car, or a connected car, or an autonomous car, or a vehicle device, or a motorcycle or V2X (Vehicle to Everything) communication module (e.g. Vehicle to Vehicle communication module, Vehicle to Infrastructure communication module, Vehicle to People communication module and Vehicle to Network communication module).

### (R)AN Node

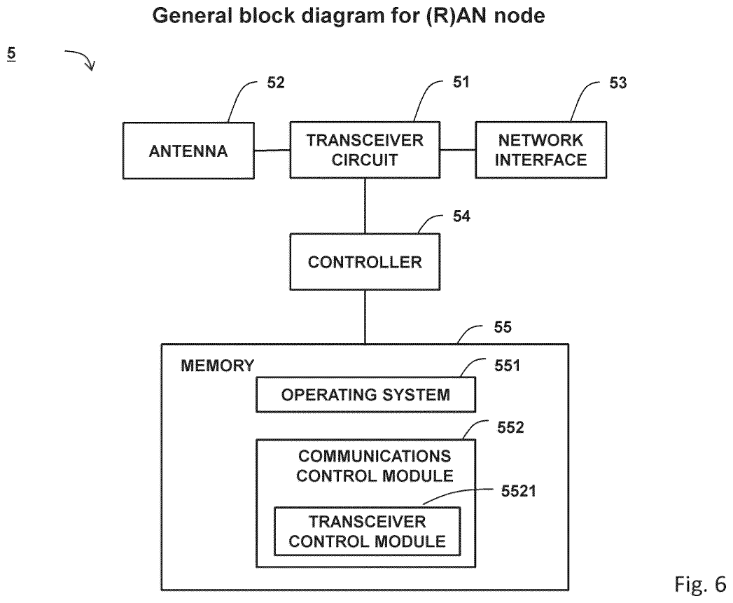

FIG. 6 is a block diagram illustrating the main components of an exemplary (R)AN node 5, for example a base station (′eNB′ in LTE, ‘gNB’ in 5G, a base station for 5G beyond, a base station for 6G). As shown, the (R)AN node 5 includes a transceiver circuit 51 which is operable to transmit signals to and to receive signals from connected UE(s) 3 via one or more antennas 52 and to transmit signals to and to receive signals from other network nodes (either directly or indirectly) via a network interface 53. A controller 54 controls the operation of the (R)AN node 5 in accordance with software stored in a memory 55. Software may be pre-installed in the memory and/or may be downloaded via the telecommunication network or from a removable data storage device (RMD), for example. The software includes, among other things, an operating system 551 and a communications control module 552 having at least a transceiver control module 5521.

The communications control module 552 (using its transceiver control sub-module) is responsible for handling (generating/sending/receiving) signalling between the (R)AN node 5 and other nodes, such as the UE 3, another (R)AN node 5, the AMF 70 and the UPF 72 (e.g. directly or indirectly). The signalling may include, for example, appropriately formatted signalling messages relating to a radio connection and a connection with the core network 7 (for a particular UE 3), and in particular, relating to connection establishment and maintenance (e.g.

RRC connection establishment and other RRC messages), NG Application Protocol (NGAP) messages (i.e. messages by N2 reference point) and Xn application protocol (XnAP) messages (i.e. messages by Xn reference point), etc. Such signalling may also include, for example, broadcast information (e.g. Master Information and System information) in a sending case.

The controller 54 is also configured (by software or hardware) to handle related tasks such as, when implemented, UE mobility estimate and/or moving trajectory estimation.

The (R)AN node 5 may support the Non-Public Network (NPN), The NPN may be a Stand-alone Non-Public Network (SNPN) or a Public Network Integrated NPN (PNI-NPN).

The Current RAN 501 and the Candidate RAN 502 may have same components to the (R)AN node 5. The (R)AN node 5 may be expressed as a RAN node, RAN, (R)AN etc.

### System Overview of (R)AN Node 5 Based on O-RAN Architecture

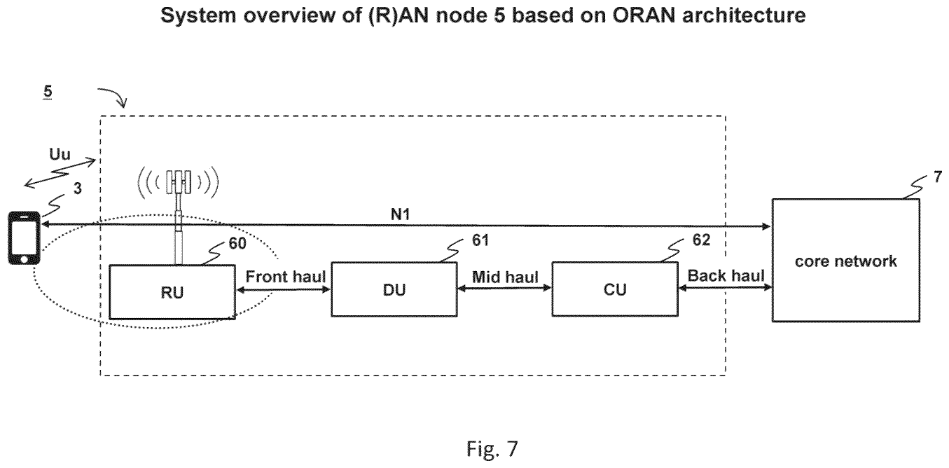

FIG. 7 schematically illustrates a (R)AN node 5 based on O-RAN architecture to which the (R)AN node 5 aspects are applicable.

The (R)AN node 5 based on O-RAN architecture represents a system overview in which the (R)AN node is split into a Radio Unit (RU) 60, Distributed Unit (DU) 61 and Centralized Unit (CU) 62. In some aspects, each unit may be combined. For example, the RU 60 can be integrated/combined with the DU 61 as an integrated/combined unit, the DU 61 can be integrated/combined with the CU 62 as another integrated/combined unit. Any functionality in the description for a unit (e.g. one of RU 60, DU 61 and CU 62) can be implemented in the integrated/combined unit above. Further, CU 62 can separate into two functional units such as CU Control plane (CP) and CU User plane (UP). The CU CP has a control plane functionality in the (R)AN node 5. The CU UP has a user plane functionality in the (R)AN node 5. Each CU CP is connected to the CU UP via an appropriate interface (such as the so-called “E1” interface and/or the like).

The UE 3 and a respective serving RU 60 are connected via an appropriate air interface (for example the so-called “Uu” interface and/or the like). Each RU 60 is connected to the DU 61 via an appropriate interface (such as the so-called “Front haul”, “Open Front haul”, “F1” interface and/or the like). Each DU 61 is connected to the CU 62 via an appropriate interface (such as the so-called “Mid haul”, “Open Mid haul”, “E2” interface and/or the like). Each CU 62 is also connected to nodes in the core network 7 (such as the so-called core network nodes) via an appropriate interface (such as the so-called “Back haul”, “Open Back haul”, “N2”/“N3” interface(s) and/or the like). In addition, a user plane part of the DU 61 can also be connected to the core network nodes 7 via an appropriate interface (such as the so-called “N3” interface(s) and/or the like).

Depending on functionality split among the RU 60, DU 61 and CU 62, each unit provides some of the functionality that is provided by the (R)AN node 5. For example, the RU 60 may provide a functionalities to communicate with a UE 3 over air interface, the DU 61 may provide functionalities to support MAC layer and RLC layer, the CU 62 may provide functionalities to support PDCP layer, SDAP layer and RRC layer.

### Radio Unit (RU)

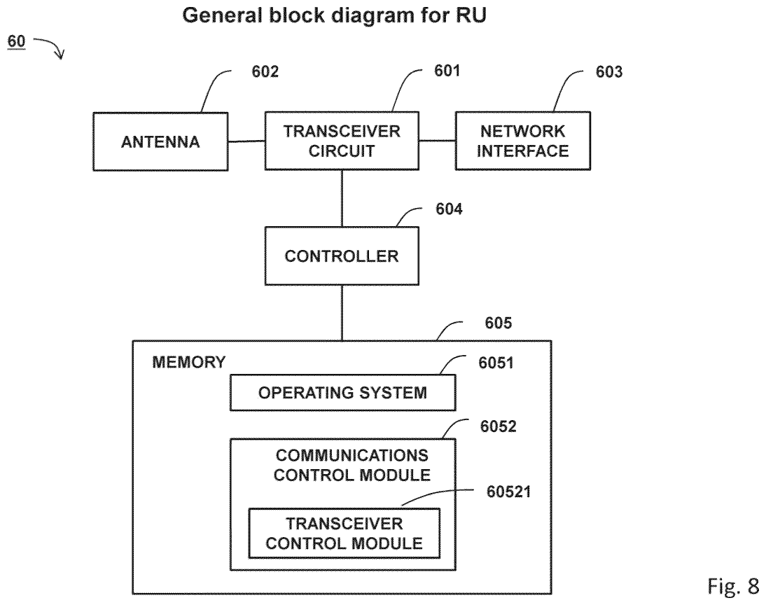

FIG. 8 is a block diagram illustrating the main components of an exemplary RU 60, for example a RU part of base station (′eNB′ in LTE, ‘gNB’ in 5G, a base station for 5G beyond, a base station for 6G). As shown, the RU 60 includes a transceiver circuit 601 which is operable to transmit signals to and to receive signals from connected UE(s) 3 via one or more antennas 602 and to transmit signals to and to receive signals from other network nodes or network unit (either directly or indirectly) via a network interface 603. A controller 604 controls the operation of the RU 60 in accordance with software stored in a memory 605.

Software may be pre-installed in the memory and/or may be downloaded via the telecommunication network or from a removable data storage device (RMD), for example. The software includes, among other things, an operating system 6051 and a communications control module 6052 having at least a transceiver control module 60521.

The communications control module 6052 (using its transceiver control sub-module) is responsible for handling (generating/sending/receiving) signalling between the RU 60 and other nodes or units, such as the UE 3, another RU 60 and DU 61 (e.g. directly or indirectly). The signalling may include, for example, appropriately formatted signalling messages relating to a radio connection and a connection with the RU 60 (for a particular UE 3), and in particular, relating to MAC layer and RLC layer.

The controller 604 is also configured (by software or hardware) to handle related tasks such as, when implemented, UE mobility estimate and/or moving trajectory estimation.

The RU 60 may support the Non-Public Network (NPN), The NPN may be a Stand-alone Non-Public Network (SNPN) or a Public Network Integrated NPN (PNI-NPN).

As described above, the RU 60 can be integrated/combined with the DU 61 as an integrated/combined unit. Any functionality in the description for the RU 60 can be implemented in the integrated/combined unit above.

### Distributed Unit (DU)

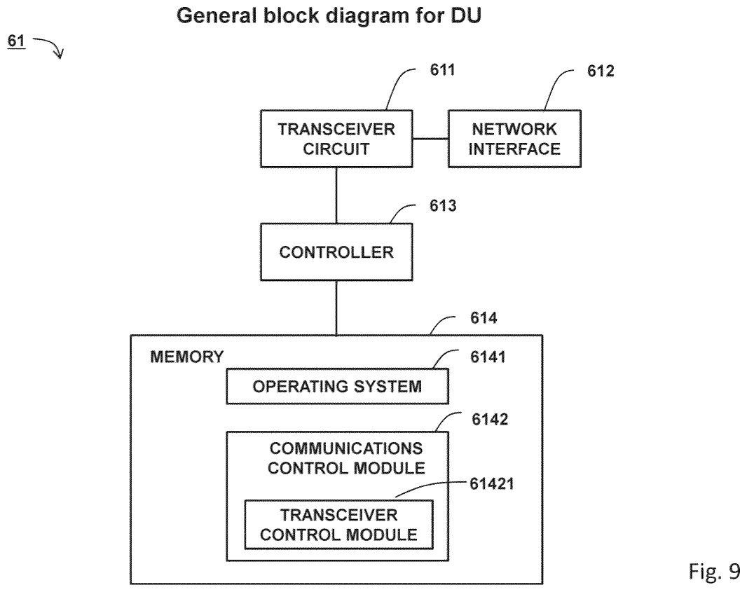

FIG. 9 is a block diagram illustrating the main components of an exemplary DU 61, for example a DU part of a base station (′eNB′ in LTE, ‘gNB’ in 5G, a base station for 5G beyond, a base station for 6G). As shown, the apparatus includes a transceiver circuit 611 which is operable to transmit signals to and to receive signals from other nodes or units (including the RU 60) via a network interface 612. A controller 613 controls the operation of the DU 61 in accordance with software stored in a memory 614. Software may be pre-installed in the memory 614 and/or may be downloaded via the telecommunication network or from a removable data storage device (RMD), for example. The software includes, among other things, an operating system 6141 and a communications control module 6142 having at least a transceiver control module 61421. The communications control module 6142 (using its transceiver control module 61421 is responsible for handling (generating/sending/receiving) signalling between the DU 61 and other nodes or units, such as the RU 60 and other nodes and units.

The DU 61 may support the Non-Public Network (NPN), The NPN may be a Stand-alone Non-Public Network (SNPN) or a Public Network Integrated NPN (PNI-NPN).

As described above, the RU 60 can be integrated/combined with the DU 61 or CU 62 as an integrated/combined unit. Any functionality in the description for DU 61 can be implemented in one of the integrated/combined unit above.

### Centralized Unit (CU)

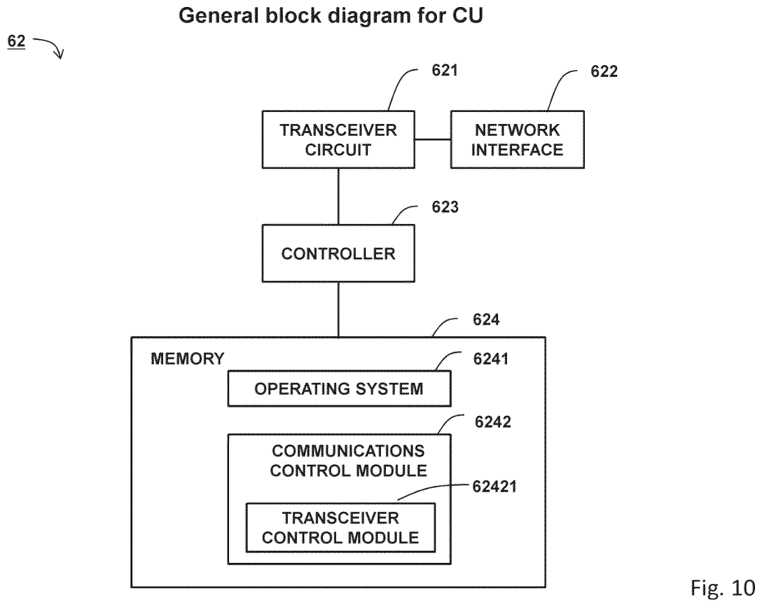

FIG. 10 is a block diagram illustrating the main components of an exemplary CU 62, for example a CU part of base station (′eNB′ in LTE, ‘gNB’ in 5G, a base station for 5G beyond, a base station for 6G). As shown, the apparatus includes a transceiver circuit 621 which is operable to transmit signals to and to receive signals from other nodes or units (including the DU 61) via a network interface 622. A controller 623 controls the operation of the CU 62 in accordance with software stored in a memory 624. Software may be pre-installed in the memory 624 and/or may be downloaded via the telecommunication network or from a removable data storage device (RMD), for example. The software includes, among other things, an operating system 6241 and a communications control module 6242 having at least a transceiver control module 62421. The communications control module 6242 (using its transceiver control module 62421 is responsible for handling (generating/sending/receiving) signalling between the CU 62 and other nodes or units, such as the DU 61 and other nodes and units.

The CU 62 may support the Non-Public Network (NPN), The NPN may be a Stand-alone Non-Public Network (SNPN) or a Public Network Integrated NPN (PNI-NPN).

As described above, the CU 62 can be integrated/combined with the DU 61 as an integrated/combined unit. Any functionality in the description for the CU 62 can be implemented in the integrated/combined unit above.

### AMF

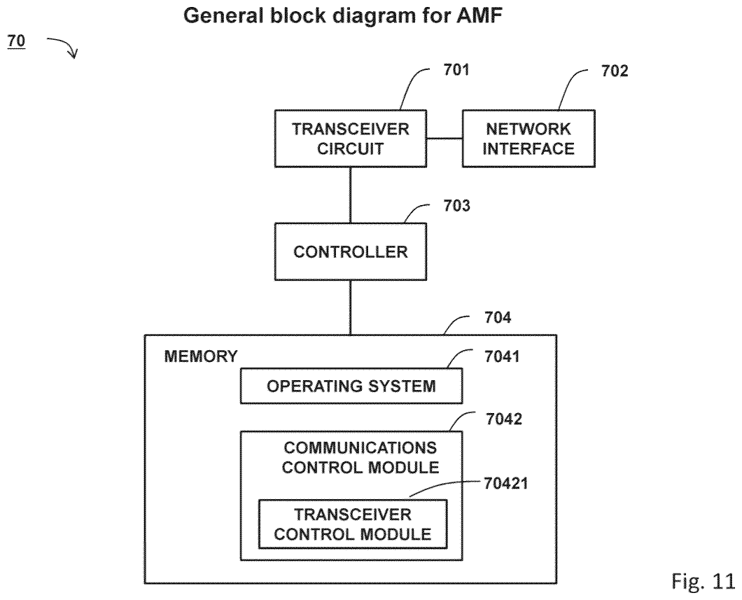

FIG. 11 is a block diagram illustrating the main components of the AMF 70. As shown, the apparatus includes a transceiver circuit 701 which is operable to transmit signals to and to receive signals from other nodes (including the UE 3, the NSSF 76) via a network interface 702. A controller 703 controls the operation of the AMF 70 in accordance with software stored in a memory 704. Software may be pre-installed in the memory 704 and/or may be downloaded via the telecommunication network or from a removable data storage device (RMD), for example. The software includes, among other things, an operating system 7041 and a communications control module 7042 having at least a transceiver control module 70421. The communications control module 7042 (using its transceiver control module 70421 is responsible for handling (generating/sending/receiving) signalling between the AMF 70 and other nodes, such as the UE 3 (e.g. via the (R)AN node 5) and other core network nodes (including core network nodes in the HPLMN of the UE 3 when the UE 3 is roaming-in. Such signalling may include, for example, appropriately formatted signalling messages (e.g. a registration request message and associated response messages) relating to access and mobility management procedures (for the UE 3).

The AMF 70 may support the Non-Public Network (NPN), The NPN may be a Stand-alone Non-Public Network (SNPN) or a Public Network Integrated NPN (PNI-NPN). An AMF 7001 and an AMF 7002 may have same components to the AMF 70.

### PCF

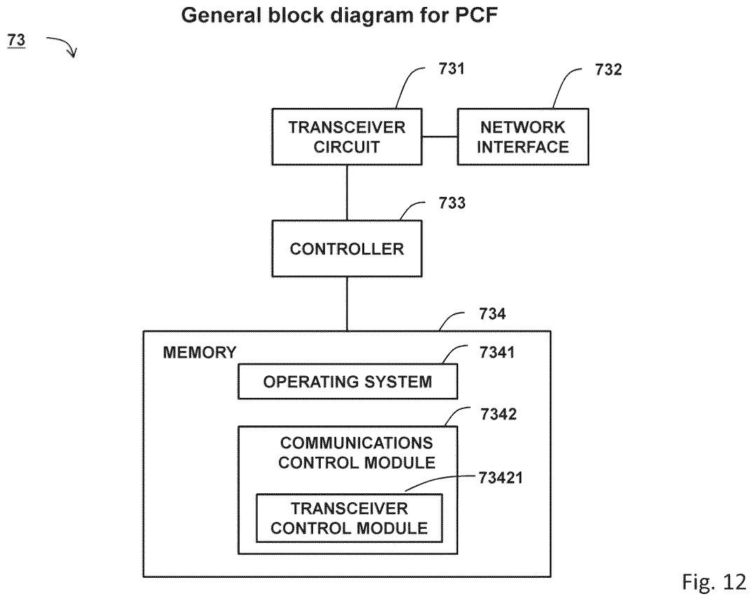

FIG. 12 is a block diagram illustrating the main components of the PCF 73. As shown, the apparatus includes a transceiver circuit 731 which is operable to transmit signals to and to receive signals from other nodes (including the AMF 70) via a network interface 732. A controller 733 controls the operation of the PCF 73 in accordance with software stored in a memory 734. Software may be pre-installed in the memory 734 and/or may be downloaded via the telecommunication network or from a removable data storage device (e.g. a removable memory device (RMD)), for example. The software includes, among other things, an operating system 7341 and a communications control module 7342 having at least a transceiver control module 73421. The communications control module 7342 (using its transceiver control module 73421 is responsible for handling (generating/sending/receiving) signalling between the PCF 73 and other nodes, such as the AMF 70 and other core network nodes (including core network nodes in the HPLMN of the UE 3 when the UE 3 is roaming-in. Such signalling may include, for example, appropriately formatted signalling messages (e.g. a HTTP restful methods based on the service based interfaces) relating to policy management procedures (for the UE 3).

The PCF 73 may support the Non-Public Network (NPN), The NPN may be a Stand-alone Non-Public Network (SNPN) or a Public Network Integrated NPN (PNI-NPN). A PCF 7301 and a PCF 7302 may have same components to the PCF 73.

### AUSF

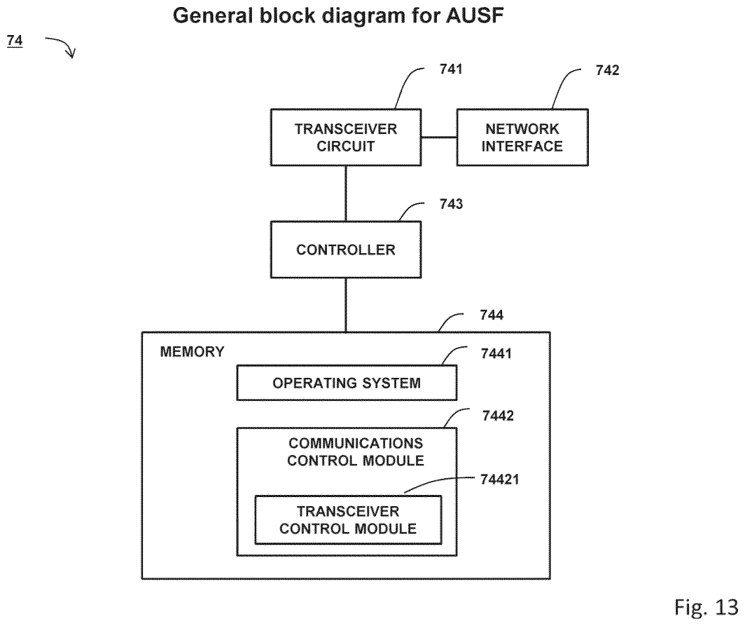

FIG. 13 is a block diagram illustrating the main components of the AUSF 74. As shown, the apparatus includes a transceiver circuit 741 which is operable to transmit signals to and to receive signals from other nodes (including the UDM 75) via a network interface 742. A controller 743 controls the operation of the AUSF 74 in accordance with software stored in a memory 744. Software may be pre-installed in the memory 744 and/or may be downloaded via the telecommunication network or from a removable data storage device (e.g. a removable memory device (RMD)), for example. The software includes, among other things, an operating system 7441 and a communications control module 7442 having at least a transceiver control module 74421. The communications control module 7442 (using its transceiver control module 74421 is responsible for handling (generating/sending/receiving) signalling between the AUSF 74 and other nodes, such as the AMF 70 and other core network nodes (including core network nodes in the HPLMN of the UE 3 when the UE 3 is roaming-in. Such signalling may include, for example, appropriately formatted signalling messages (e.g. a HTTP restful methods based on the service based interfaces) relating to policy management procedures (for the UE 3).

The AUSF 74 may support the Non-Public Network (NPN), The NPN may be a Stand-alone Non-Public Network (SNPN) or a Public Network Integrated NPN (PNI-NPN).

### UDM

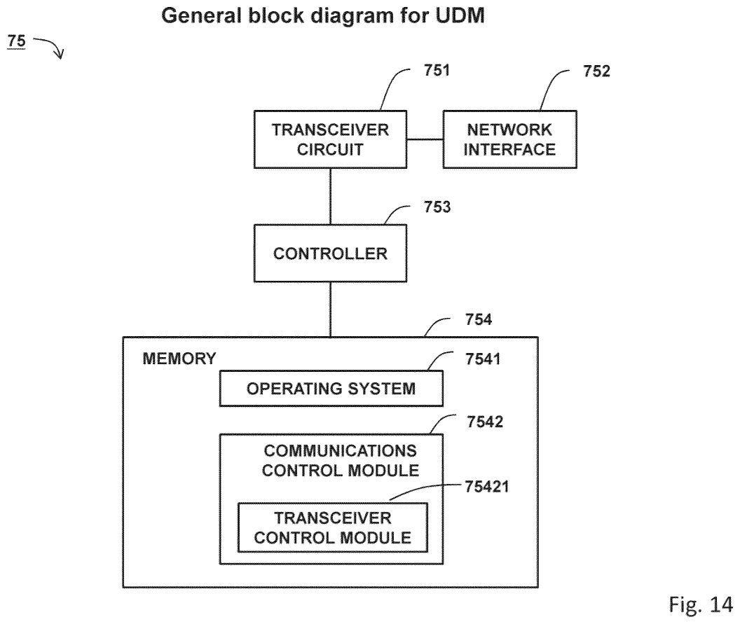

FIG. 14 is a block diagram illustrating the main components of the UDM 75. As shown, the apparatus includes a transceiver circuit 751 which is operable to transmit signals to and to receive signals from other nodes (including the AMF 70) via a network interface 752. A controller 753 controls the operation of the UDM 75 in accordance with software stored in a memory 754. Software may be pre-installed in the memory 754 and/or may be downloaded via the telecommunication network or from a removable data storage device (RMD), for example. The software includes, among other things, an operating system 7541 and a communications control module 7542 having at least a transceiver control module 75421. The communications control module 7542 (using its transceiver control module 75421 is responsible for handling (generating/sending/receiving) signalling between the UDM 75 and other nodes, such as the AMF 70 and other core network nodes (including core network nodes in the VPLMN of the UE 3 when the UE 3 is roaming-out. Such signalling may include, for example, appropriately formatted signalling messages (e.g. a HTTP restful methods based on the service based interfaces) relating to mobility management procedures (for the UE 3).

The UDM 75 may support the Non-Public Network (NPN), The NPN may be a Stand-alone Non-Public Network (SNPN) or a Public Network Integrated NPN (PNI-NPN).

### NSSF

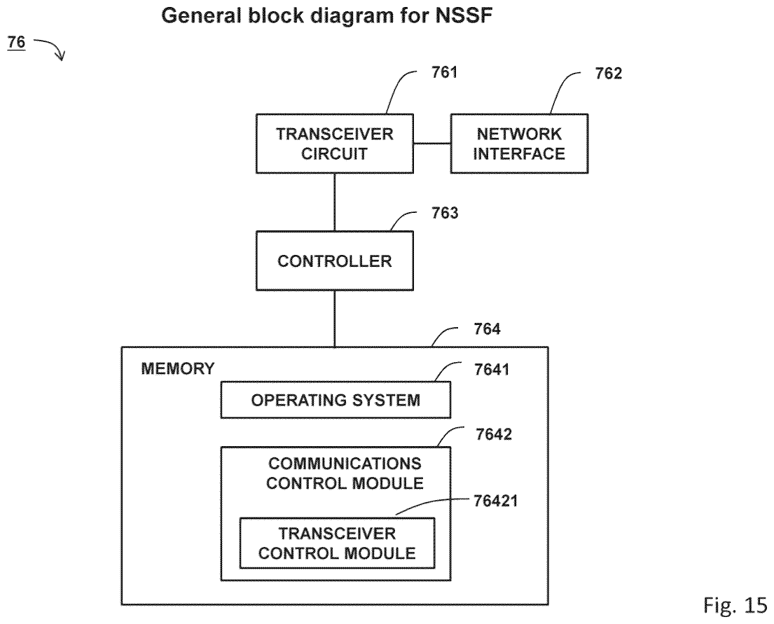

FIG. 15 is a block diagram illustrating the main components of the NSSF 76. As shown, the apparatus includes a transceiver circuit 761 which is operable to transmit signals to and to receive signals from other nodes (including the AMF 70) via a network interface 762. A controller 763 controls the operation of the NSSF 76 in accordance with software stored in a memory 764. Software may be pre-installed in the memory 764 and/or may be downloaded via the telecommunication network or from a removable data storage device (RMD), for example. The software includes, among other things, an operating system 7641 and a communications control module 7642 having at least a transceiver control module 76421. The communications control module 7642 (using its transceiver control module 76421 is responsible for handling (generating/sending/receiving) signalling between the NSSF 76 and other nodes, such as the AMF 70 and other core network nodes (including core network nodes in the VPLMN of the UE 3 when the UE 3 is roaming-out. Such signalling may include, for example, appropriately formatted signalling messages (e.g. a HTTP restful methods based on the service based interfaces) relating to mobility management procedures (for the UE 3).

The NSSF 76 may support the Non-Public Network (NPN), The NPN may be a Stand-alone Non-Public Network (SNPN) or a Public Network Integrated NPN (PNI-NPN).

The whole or part of the example Aspects disclosed above can be described as, but not limited to, the following.

### 5.3.4.3.4 Network Slice Based Cell Reselection

When one or more S-NSSAI(s) are associated with NSAG(s), the UE may perform Network Slice based cell reselection as described in TS 38.300 [27], TS 38.304 [50], TS 38.331 and TS 24.501 [47].

When providing NSAG Information to the UE, the AMF should also provide the NSAG priority information for the NSAGs provided in the NSAG Information. The AMF determines the NSAG priority information based on operator's policy. If the UE has received NSAG priority information from the AMF, the UE shall use the NSAG priority information provided by the AMF for cell reselection as described below. If the UE has not received any NSAG priority information from the AMF, the UE shall not use Network Slice based cell reselection at all. The UE NAS provides to the UE AS the NSAGs and their priorities as received from the AMF for the S-NSSAIs in the Allowed NSSAI and pending NSSAI of the 3GPP access as input to cell reselection. If the UE NAS provided to the UE AS the NSAGs and their priorities for the S-NSSAI(s) from the Pending NSSAI and one or more S-NSSAI(s) from the Pending NSSAI were rejected, the UE NAS updates again the UE AS with the NSAGs and their priorities for the Allowed NSSAI only. Except when the UE intends to register with a new set of S-NSSAIs with a Requested NSSAI different from the current Allowed NSSAI, in which case the UE NAS provides to the UE AS layer the NSAGs and their priorities as received from the AMF for the S-NSSAIs in the Requested NSSAI and the pending NSSAI of the 3GPP access if stored in the UE, and this may trigger a cell reselection, before sending the Registration Request including the new Requested NSSAI.

NOTE: How the UE NAS provides the NSAGs priorities to UE AS is based internal UE interface, and not specified.

### 4.6 Network Slicing

### 4.6.1 General

The 5GS supports network slicing as described in 3GPP TS 23.501 [8]. Within a PLMN or SNPN, a network slice is identified by an S-NSSAI, which is comprised of a slice/service type (SST) and a slice differentiator (SD). Inclusion of an SD in an S-NSSAI is optional. A set of one or more S-NSSAIs is called the NSSAI. The following NSSAIs are defined in 3GPP TS 23.501 [8]:
a) configured NSSAI;
b) requested NSSAI;
c) allowed NSSAI;
d) subscribed S-NSSAIs;
e) pending NSSAI; and
f) abandon NSSAI.

The following NSSAIs are defined in the present document:
a) rejected NSSAI for the current PLMN or SNPN;
b) rejected NSSAI for the current registration area;
c) rejected NSSAI for the failed or revoked NSSAA; and
d) rejected NSSAI for the maximum number of UEs reached.

In roaming scenarios, rejected NSSAI for the current PLMN or SNPN, or rejected NSSAI for the current registration area, or rejected NSSAI for the maximum number of UEs reached includes one or more S-NSSAI for the current PLMN and also contains a set of mapped S-NSSAI(s) if available. An S-NSSAI included in the rejected NSSAI for the failed or revoked NSSAA is an HPLMN S-NSSAI.

In case of a PLMN, a serving PLMN may configure a UE with the configured NSSAI per PLMN, and NSSRG information if the UE has indicated it support the subscription-based restrictions to simultaneous registration of network slices feature. In addition, the HPLMN may configure a UE with a single default configured NSSAI and consider the default configured NSSAI as valid in a PLMN for which the UE has neither a configured NSSAI nor an allowed NSSAI.

NOTE 1: The value(s) used in the default configured NSSAI are expected to be commonly decided by all roaming partners, e.g., values standardized by 3GPP or other bodies.

In case of an SNPN, the SNPN may configure a UE with a configured NSSAI applicable to the SNPN, and NSSRG information if the UE has indicated it support the subscription-based restrictions to simultaneous registration of network slices feature, if the UE is neither registering nor registered for onboarding services in SNPN. In addition, the credential holder may configure a single default configured NSSAI associated with the selected entry of the “list of subscriber data” or the PLMN subscription and consider the default configured NSSAI as valid in a SNPN for which the UE has neither a configured NSSAI nor an allowed NSSAI. If the UE is registering or registered for onboarding services in SNPN, the serving SNPN shall not provide a configured NSSAI to the UE.

The allowed NSSAI and the rejected NSSAI for the current registration area are managed per access type independently, i.e. 3GPP access or non-3GPP access, and is applicable for the registration area. If the UE does not have a valid registration area, the rejected NSSAI for the current registration area is applicable to the tracking area on which it was received. If the registration area contains TAIs belonging to different PLMNs, which are equivalent PLMNs, the allowed NSSAI and the rejected NSSAI for the current registration area are applicable to these PLMNs in this registration area.

The allowed NSSAI that is associated with a registration area containing TAIs belonging to different PLMNs, which are equivalent PLMNs, can be used to form the requested NSSAI for any of the equivalent PLMNs when the UE is outside of the registration area where the allowed NSSAI was received.

When the network slice-specific authentication and authorization procedure is to be initiated for one or more S-NSSAIs in the requested NSSAI or the network slice-specific authentication and authorization procedure is ongoing for one or more S-NSSAIs, these S-NSSAI(s) will be included in the pending NSSAI. When the network slice-specific authentication and authorization procedure is completed for an S-NSSAI that has been in the pending NSSAI, the S-NSSAI will be moved to the allowed NSSAI or rejected NSSAI depending on the outcome of the procedure. The AMF sends the updated allowed NSSAI to the UE over the same access of the requested S-NSSAI. The AMF sends the updated rejected NSSAI over either 3GPP access or non-3GPP access. The pending NSSAI is managed regardless of access type i.e. the pending NSSAI is applicable to both 3GPP access and non-3GPP access for the current PLMN even if sent over only one of the accesses. If the registration area contains TAIs belonging to different PLMNs, which are equivalent PLMNs, the pending NSSAI is applicable to these PLMNs in this registration area. When a UE is no longer interested for a S-NSSAI in the pending NSSAI, the UE initiate mobility registration procedure and the UE sends abandon NSSAI containing the pending S-NSSAI(s) for which the UE is not interested anymore in the registration request message.

The rejected NSSAI for the current PLMN or SNPN is applicable for the whole registered PLMN or SNPN. The AMF shall only send a rejected NSSAI for the current PLMN when the registration area consists of TAIs that only belong to the registered PLMN. If the UE receives a rejected NSSAI for the current PLMN, and the registration area also contains TAIs belonging to different PLMNs, the UE shall treat the received rejected NSSAI for the current PLMN as applicable to the whole registered PLMN.

The rejected NSSAI for the failed or revoked NSSAA includes one or more S-NSSAIs that have failed the network slice-specific authentication and authorization or for which the authorization have been revoked, and are applicable for the whole registered PLMN or SNPN.

The rejected NSSAI for the maximum number of UEs reached is applicable for the whole registered PLMN or SNPN, and the access type over which the rejected NSSAI was sent. The AMF shall send a rejected NSSAI including S-NSSAI(s) with the rejection cause “S-NSSAI not available due to maximum number of UEs reached”, when one or more S-NSSAIs are indicated that the maximum number of UEs has been reached. If the timer T3526 associated with the S-NSSAI(s) was started upon reception of the rejected NSSAI for the maximum number of UEs reached, the UE may remove the S-NSSAI(s) from the rejected NSSAI including S-NSSAI(s) with the rejection cause “S-NSSAI not available due to maximum number of UEs reached”, if the timer T3526 associated with the S-NSSAI(s) expires. If one or more S-NSSAIs are removed from the rejected NSSAI for the maximum number of UEs reached, the timer T3526 associated with the removed S-NSSAI(s) shall be stopped, if running. The UE shall not stop the timer T3526 if the UE selects an E-UTRA cell connected to EPC.

If the UE receives a rejected NSSAI for the maximum number of UEs reached, the registration area contains TAIs belonging to different PLMNs, which are equivalent PLMNs, the UE shall treat the received rejected NSSAI for the maximum number of UEs reached as applicable to these equivalent PLMNs when the UE is in this registration area.

NOTE 2: Based on local policies, the UE can remove an S-NSSAI from the rejected NSSAI for the failed or revoked NSSAA when the UE wants to register to the slice identified by this S-NSSAI.

NOTE 3: Based on network local policy, network slice-specific authentication and authorization procedure can be initiated by the AMF for an S-NSSAI in rejected NSSAI for the failed or revoked NSSAA when the S-NSSAI is requested by the UE based on its local policy.

NOTE 4: At least one S-NSSAI in the default configured NSSAI or at least one default S-NSSAI is recommended as not subject to network slice-specific authentication and authorization, in order to ensure that at least one PDU session can be established to access service, even when Network Slice-specific Authentication and Authorization fails.

NOTE 5: At least one S-NSSAI in the default configured NSSAI or in the subscribed S-NSSAIs marked as default S-NSSAI is recommended as not subject to network slice admission control, in order to ensure that at least one PDU session can be established to access service.

NOTE 6: The rejected NSSAI can be provided by the network via either Rejected NSSAI IE or the Extended rejected NSSAI IE.

### 4.6.2 Mobility Management Aspects

### 4.6.2.1 General

Upon registration to a PLMN or SNPN (except for the registration procedure for periodic registration update, the initial registration for onboarding services in SNPN, and the registration procedure for mobility registration update when registered for onboarding services in SNPN), the UE shall send to the AMF the requested NSSAI which includes one or more S-NSSAIs of the allowed NSSAI for the PLMN or SNPN or the configured NSSAI for the PLMN or SNPN and corresponds to the network slice(s) to which the UE intends to register with, if:
a) the UE has a configured NSSAI for the current PLMN or SNPN;
b) the UE has an allowed NSSAI for the current PLMN or SNPN; or
c) the UE has neither allowed NSSAI for the current PLMN or SNPN nor configured NSSAI for the current PLMN or SNPN and has a default configured NSSAI. In this case the UE indicates to the AMF that the requested NSSAI is created from the default configured NSSAI.

Other than S-NSSAIs contained in the NSSAIs described above, the requested NSSAI can be formed based on the S-NSSAI(s) available in the UE (see subclause 5.5.1.3.2 for further details). In roaming scenarios, the UE shall also provide the mapped S-NSSAI(s) for the requested NSSAI, if available. The AMF verifies if the requested NSSAI is permitted based on the subscribed S-NSSAIs in the UE subscription and optionally the mapped S-NSSAI(s) provided by the UE, and if so then the AMF shall provide the UE with the allowed NSSAI for the PLMN or SNPN, and shall also provide the UE with the mapped S-NSSAI(s) for the allowed NSSAI for the PLMN or SNPN if available. The AMF shall ensure that there are not two or more S-NSSAIs of the allowed NSSAI which are mapped to the same S-NSSAI of the HPLMN or SNPN. If
a) all the S-NSSAIs included in the requested NSSAI are rejected, or the requested NSSAI was not included by the UE;
b) there is no default S-NSSAI(s) or all subscribed S-NSSAIs marked as default are not allowed; and
c) the UE is neither registering nor registered for onboarding services in SNPN and the UE is neither registering nor registered for emergency services; then the AMF may reject the registration request (see subclauses 5.5.1.2.5 and 5.5.1.3.5 for further details).

The set of network slice(s) for a UE can be changed at any time while the UE is registered to a PLMN or SNPN, and the change may be initiated by the network or the UE. In this case, the allowed NSSAI and associated registration area may be changed during the registration procedure or the generic UE configuration update procedure. The configured NSSAI and the rejected NSSAI may be changed during the registration procedure or the generic UE configuration update procedure. The default configured NSSAI may be changed by sending a UE parameters update transparent container to the UE during the NAS transport procedure. The pending NSSAI may be changed during the registration procedure.

In addition, using the generic UE configuration update procedure, the network may trigger the registration procedure in order to update the allowed NSSAI. When a UE is no longer interested for a S-NSSAI in the pending NSSAI, the UE initiate mobility registration procedure and the UE sends abandon NSSAI containing the pending S-NSSAI(s) for which the UE is not interested anymore in the registration request message. If the UE needs to send a requested NSSAI to the AMF, then the S-NSSAI in the Requested NSSAI shall share at least one common NSSRG group. The S-NSSAIs in the abandon NSSAI shall not be considered in NSSRG procedure. When the AMF receives registration request message with abandon NSSAI, the AMF removes the S-NSSAI(s) present in the abandon NSSAI from the pending NSSAI list. The UE may abort the NSSAA procedure for the S-NSSAI(s) present in the abandon NSSAI. The AMF sends registration accept message with the latest allowed NSSAI. The S-NSSAI(s) in the new allowed shall share at least one NSSRG value. The UE in NB-N1 mode does not include the requested NSSAI during the registration procedure if the 5GS registration type IE indicates “mobility registration updating”, procedure is not initiated to change the slice(s) that the UE is currently registered to, and the UE is still in the current registration area. The UE does not include the requested NSSAI during the registration procedure if the 5GS registration type IE indicates “SNPN onboarding registration” or the UE is registered for onboarding services in SNPN.

The AMF does not include the allowed NSSAI during a registration procedure with the 5GS registration type IE indicating “mobility registration updating” except if the allowed NSSAI has changed for the UE. The UE considers the last received allowed NSSAI as valid until the UE receives a new allowed NSSAI. The AMF does not include the allowed NSSAI during a registration procedure with the 5GS registration type IE indicating “SNPN onboarding registration” or during a registration procedure when the UE is registered for onboarding services in SNPN.

### 5.5.1.3.2 Mobility and Periodic Registration Update Initiation

The UE in state 5GMM-REGISTERED shall initiate the registration procedure for mobility and periodic registration update by sending a REGISTRATION REQUEST message to the AMF,
a) when the UE detects that the current TAI is not in the list of tracking areas that the UE previously registered in the AMF;
b) when the periodic registration updating timer T3512 expires in 5GMM-IDLE mode;
c) when the UE receives a CONFIGURATION UPDATE COMMAND message indicating “registration requested” in the Registration requested bit of the Configuration update indication IE as specified in subclauses 5.4.4.3;
d) when the UE in state 5GMM-REGISTERED. ATTEMPTING-REGISTRATION-UPDATE either receives a paging or the UE receives a NOTIFICATION message with access type indicating 3GPP access over the non-3GPP access for PDU sessions associated with 3GPP access;

NOTE 1: As an implementation option, MUSIM UE is allowed to not respond to paging based on the information available in the paging message, e.g. voice service indication.
e) upon inter-system change from S1 mode to N1 mode and if the UE previously had initiated an attach procedure or a tracking area updating procedure when in S1 mode;
f) when the UE receives an indication of “RRC Connection failure” from the lower layers and does not have signalling pending (i.e. when the lower layer requests NAS signalling connection recovery) except for the case specified in subclause 5.3.1.4;
g) when the UE changes the 5GMM capability or the S1 UE network capability or both;
h) when the UE's usage setting changes;
i) when the UE needs to change the slice(s) it is currently registered to;
j) when the UE changes the UE specific DRX parameters;
k) when the UE in state 5GMM-REGISTERED. ATTEMPTING-REGISTRATION-UPDATE receives a request from the upper layers to establish an emergency PDU session or perform emergency services fallback;
l) when the UE needs to register for SMS over NAS, indicate a change in the requirements to use SMS over NAS, or de-register from SMS over NAS;
m) when the UE needs to indicate PDU session status to the network after performing a local release of PDU session(s) as specified in subclauses 6.4.1.5 and 6.4.3.5;
n) when the UE in 5GMM-IDLE mode changes the radio capability for NG-RAN or E-UTRAN;
o) when the UE receives a fallback indication from the lower layers and does not have signalling pending (i.e. when the lower layer requests NAS signalling connection recovery, see subclauses 5.3.1.4 and 5.3.1.2);
p) void;
q) when the UE needs to request new LADN information;
r) when the UE needs to request the use of MICO mode or needs to stop the use of MICO mode or to request the use of new T3324 value;
s) when the UE in 5GMM-CONNECTED mode with RRC inactive indication enters a cell in the current registration area belonging to an equivalent PLMN of the registered PLMN and not belonging to the registered PLMN;
t) when the UE receives over 3GPP access a SERVICE REJECT message or a DL NAS TRANSPORT message, with the 5GMM cause value set to #28 “Restricted service area”;
u) when the UE needs to request the use of eDRX, when a change in the eDRX usage conditions at the UE requires different extended DRX parameters, or needs to stop the use of eDRX;

NOTE 2: A change in the eDRX usage conditions at the UE can include e.g. a change in the UE configuration, a change in requirements from upper layers or the battery running low at the UE.
v) when the UE supporting 5G-SRVCC from NG-RAN to UTRAN changes the mobile station classmark 2 or the supported codecs;
w) when the UE in state 5GMM-REGISTERED. ATTEMPTING-REGISTRATION-UPDATE decides to request new network slices after being rejected due to no allowed network slices requested, or request S-NSSAI(s) which have been removed from the rejected NSSAI for the maximum number of UEs reached;
x) when the UE is not in NB-N1 mode and the applicable UE radio capability ID for the current UE radio configuration changes due to a revocation of the network-assigned UE radio capability IDs by the serving PLMN or SNPN;
y) when the UE receives a REGISTRATION REJECT message with 5GMM cause values #3, #6 or #7 without integrity protection over another access;
z) when the UE needs to request new ciphering keys for ciphered broadcast assistance data;
za) when due to manual CAG selection the UE has selected a CAG-ID which is not included in the “allowed CAG list” for the selected PLMN or a CAG-ID in a PLMN for which the entry in the “CAG information list” does not exist or when the UE has selected, without selecting a CAG-ID, a PLMN for which the entry in the “CAG information list” includes an “indication that the UE is only allowed to access 5GS via CAG cells”;
zb) when the UE needs to start, stop or change the conditions for using the WUS assistance information or PEIPS assistance information;
zc) when the UE changes the UE specific DRX parameters in NB-N1 mode;
zd) when the UE in 5GMM-CONNECTED mode with RRC inactive indication enters a new cell with different RAT in current TAI list or not in current TAI list;
ze) when the UE enters state 5GMM-REGISTERED.NORMAL-SERVICE or 5GMM-REGISTERED.NON-ALLOWED-SERVICE (as described in subclause 5.3.5.2) over 3GPP access after the UE has sent a NOTIFICATION RESPONSE message over non-3GPP access in response to reception of a NOTIFICATION message over non-3GPP access as specified in subclause 5.6.3.1;
zf) when the UE supporting UAS services is not registered for UAS services and needs to register to the 5GS for UAS services;
zg) when the UE supporting MINT needs to perform the registration procedure for mobility and periodic registration update to register to the PLMN offering disaster roaming;
zh) when the MUSIM UE supporting the paging timing collision control needs to request a new 5G-GUTI assignment and the UE is not registered for emergency services;

NOTE 3: Based on implementation, the MUSIM UE can request a new 5G-GUTI assignment (e.g. when the lower layers request to modify the timing of the paging occasions).
zi) when the network supports the paging restriction and the MUSIM UE in state 5GMM-REGISTERED.NON-ALLOWED-SERVICE needs to requests the network to remove the paging restriction;
zj) when the UE changes the 5GS Preferred CIOT network behaviour or the EPS Preferred CIOT network behaviour;
zk) when the UE that has entered 5GMM-REGISTERED.NO-CELL-AVAILABLE and it has one or more S-NSSAI(s) in pending NSSAI, finds a suitable cell according to 3GPP TS 38.304 [28]; or
zl) when the UE is registered for disaster roaming services and receives a request from the upper layers to establish an emergency PDU session or perform emergency services fallback; and
zm) When a UE is no longer interested for a S-NSSAI contained in the stored pending list.

### 8.2.6.1 Message Definition

The REGISTRATION REQUEST message is sent by the UE to the AMF. See table 8.2.6.1.1.

Message type: REGISTRATION REQUEST

Significance: dual

Direction: UE to network

TABLE 8.2.6.1.1
REGISTRATION REQUEST message content

| IEI | Information Element | Type/Reference | Presence | Format | Length |
|---|---|---|---|---|---|
| | Extended protocol discriminator | Extended Protocol discriminator | M | V | 1 |
| | | 9.2 | | | |
| | Security header type | Security header type | M | V | 1/2 |
| | | 9.3 | | | |
| | Spare half octet | Spare half octet | M | V | 1/2 |
| | | 9.5 | | | |
| | Registration request message | Message type | M | V | 1 |
| | identity | 9.7 | | | |
| | 5GS registration type | 5GS registration type | M | V | 1/2 |
| | | 9.11.3.7 | | | |
| | ngKSI | NAS key set identifier | M | V | 1/2 |
| | | 9.11.3.32 | | | |
| | 5GS mobile identity | 5GS mobile identity | M | LV-E | 6-n |
| | | 9.11.3.4 | | | |
| C- | Non-current native NAS key set | NAS key set identifier | O | TV | 1 |
| | identifier | 9.11.3.32 | | | |
| 10 | SGMM capability | SGMM capability | O | TLV | 3-15 |
| | | 9.11.3.1 | | | |
| 2E | UE security capability | UE security capability | O | TLV | 4-10 |
| | | 9.11.3.54 | | | |
| 2F | Requested NSSAI | NSSAI | O | TLV | 4-74 |
| | | 9.11.3.37 | | | |
| 52 | Last visited registered TAI | 5GS tracking area identity | O | TV | 7 |
| | | 9.11.3.8 | | | |
| 17 | S1 UE network capability | S1 UE network capability | O | TLV | 4-15 |
| | | 9.11.3.48 | | | |
| 40 | Uplink data status | Uplink data status | O | TLV | 4-34 |
| | | 9.11.3.57 | | | |
| 50 | PDU session status | PDU session status | O | TLV | 4-34 |
| | | 9.11.3.44 | | | |
| B- | MICO indication | MICO indication | O | TV | 1 |
| | | 9.11.3.31 | | | |
| 2B | UE status | UE status | O | TLV | 3 |
| | | 19.11.3.56 | | | |
| 77 | Additional GUTI | 5GS mobile identity | O | TLV-E | 14 |
| | | 9.11.3.4 | | | |
| 25 | Allowed PDU session status | Allowed PDU session status | O | TLV | 4-34 |
| | | 8.11.3.13 | | | |
| 18 | UE's usage setting | UE's usage selling | O | TLV | 3 |
| | | 9.11.3.55 | | | |
| 51 | Requested DRX parameters | 5GS DRX parameters | O | TLV | 3 |
| | | 9.11.3.2A | | | |
| 70 | EPS NAS message container | EPS NAS message container | O | TLV-E | 4-n |
| | | 9.11.3.24 | | | |
| 74 | LADN indication | LADN indication | O | TLV-E | 3-811 |
| | | 9.11.3.29 | | | |
| 8- | Payload container type | Payicad container type | O | TV | 1 |
| | | 9.11.3.40 | | | |
| 7B | Payload container | Payload container | O | TLV-E | 4-65538 |
| | | 9.11.3.39 | | | |
| 9- | Network slicing indication | Network slicing indication | O | TV | 1 |
| | | 9.11.3.36 | | | |
| 53 | 5GS update type | 5GS update type | O | TLV | 3 |
| | | 9.11.3.9A | | | |
| 41 | Mobile station classmark 2 | Mobile station classmark 2 | O | TLV | 5 |
| | | 9.11.3.31C | | | |
| 42 | Supported codecs | Supported codec list | O | TLV | 5-n |
| | | 9.11.3.51A | | | |
| 71 | NAS message container | NAS message container | O | TLV-E | 4-n |
| | | 9.11.3.33 | | | |
| 60 | EPS bearer context status | EPS bearer context status | O | TLV | 4 |
| | | 9.11.3.23A | | | |
| 6E | Requested extended DRX | Extended DRX parameters | O | TLV | 3 |
| | parameters | 9.11.3.26A | | | |
| 6A | T3324 value | GPRS timer 3 | O | TLV | 3 |
| | | 9.11.2.5 | | | |
| 67 | UE radio capability ID | UE radio capability ID | O | TLV | 3-n |
| | | 9.11.3.68 | | | |
| 35 | Requested mapped NSSAI | Mapped NSSAI | O | TLV | 3-42 |
| | | 9.11.3.318 | | | |
| 48 | Additional information requested | Additional information requested | O | TLV | 3 |
| | | 9.11.3.12A | | | |
| 1A | Requested WUS assistance | WUS assistance information | O | TLV | 3-n |
| | information | 9.11.3.71 | | | |
| A- | N5GC indication | N5GC indication | O | TV | 1 |
| | | 9.11.3.72 | | | |
| 30 | Requested NB-N1 mode DRX | NB-N1 mode DRX parameters | O | TLV | 3 |
| | parameters | 9.11.3.73 | | | |
| 29 | UE request type | UE request type | O | TLV | 3 |
| | | 9.11.3.76 | | | |
| 28 | Paging restriction | Paging restriction | O | TLV | 3-35 |
| | | 9.11.3.77 | | | |
| 72 | Service-level-AA container | Service-level-AA container | O | TLV-E | 6-n |
| | | 9.11.2.10 | | | |
| 32 | NID | NID | O | TLV | 8 |
| | | 9.11.3.79 | | | |
| 16 | MS determined PLMN with | PLMN identity | O | TLV | 5 |
| | disaster condition | 9.11.3.85 | | | |
| 2A | Requested PEIPS assistance | PEIPS assistance information | O | TLV | 3-n |
| | information | 9.11.3.80 | | | |
| xx | Abandon NSSAI | NSSAI | O | TLV | 4-74 |
| | | 9.11.3.37 | | | |

### 8.2.6.31 Abandon NSSAI

This UE shall include this IE when a S-NSSAI is stored in pending NSSAI and the UE is no longer interested in the S-NSSAI.

### Modifications and Alternatives

Detailed aspects have been described above. As those skilled in the art will appreciate, a number of modifications and alternatives can be made to the above aspects whilst still benefiting from the disclosures embodied therein. By way of illustration only a number of these alternatives and modifications will now be described.

In the above description, the UE 3 and the network apparatus are described for ease of understanding as having a number of discrete modules (such as the communication control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above aspects, a number of software modules were described. As those skilled in the art will appreciate, the software modules may be provided in compiled or un-compiled form and may be supplied to the UE 3 and the network apparatus as a signal over a computer network, or on a recording medium. Further, the functionality performed by part or all of this software may be performed using one or more dedicated hardware circuits. However, the use of software modules is preferred as it facilitates the updating of the UE 3 and the network apparatus in order to update their functionalities.

In the above aspects, a 3GPP radio communications (radio access) technology is used. However, any other radio communications technology (e.g. WLAN, Wi-Fi, WiMAX, Bluetooth, etc.) and other fix line communications technology (e.g. BBF Access, Cable Access, optical access, etc.) may also be used in accordance with the above aspects.

Items of user equipment might include, for example, communication devices such as mobile telephones, smartphones, user equipment, personal digital assistants, laptop/tablet computers, web browsers, e-book readers and/or the like. Such mobile (or even generally stationary) devices are typically operated by a user, although it is also possible to connect so-called ‘Internet of Things’ (IoT) devices and similar machine-type communication (MTC) devices to the network.

For simplicity, the present application refers to mobile devices (or UEs) in the description but it will be appreciated that the technology described can be implemented on any communication devices (mobile and/or generally stationary) that can connect to a communications network for sending/receiving data, regardless of whether such communication devices are controlled by human input or software instructions stored in memory.

Various other modifications will be apparent to those skilled in the art and will not be described in further detail here.

As will be appreciated by one of skill in the art, the present disclosure may be embodied as a method, and system. Accordingly, the present disclosure may take the form of an entirely hardware embodiment, a software embodiment or an embodiment combining software and hardware aspects.

It will be understood that each block of the block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. A general-purpose processor may be a microprocessor, but in the alternative, the processor may be any conventional processor, controller, microcontroller, or state machine. A processor may also be implemented as a combination of computing devices, e.g., a plurality of microprocessors, one or more microprocessors, or any other such configuration.

The methods or algorithms described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor. The processor and the storage medium may reside in an ASIC.

The previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

While the disclosure has been particularly shown and described with reference to exemplary Aspects thereof, the disclosure is not limited to these Aspects. It will be understood by those of ordinary skill in the art that various changes in form and details may be made therein without departing from the spirit and scope of the present disclosure as defined by this document. For example, the Aspects above are not limited to 5GS, and the Aspects are also applicable to communication system other than 5GS (e.g., 6G system, 5G beyond system).

### Supplementary Notes

The whole or part of the example Aspects disclosed above can be described as, but not limited to, the following supplementary notes.

### Supplementary Note 1.

A method of a User Equipment (UE), the method comprising:
communicating with an Access and Mobility Management Function (AMF); and
selecting a first Network Slice Access Stratum (AS) Group (NSAG) and a first NSAG priority based on Allowed Network Slice Selection Assistance Information (NSSAI) and Pending NSSAI.

### Supplementary Note 2.

The method according to supplementary note 1,
wherein the first NSAG and the first NSAG priority are selected in Non-Access-Stratum (NAS) layer in the UE.

### Supplementary Note 3.

The method according to supplementary note 1 or 2, further comprising:
performing a first cell reselection based on the first NSAG and the first NSAG priority.

### Supplementary Note 4.

The method according to supplementary note 3,
wherein the performing the first cell reselection includes performing the first cell reselection based on the first NSAG, the first NSAG priority and the Pending NSSAI of at least one of 3GPP access and non-3GPP access.

### Supplementary Note 5.

The method according to supplementary note 3 or 4, further comprising:
receiving information related to a NSAG which is supported by a cell; and
not performing the first cell reselection in a case where the first NSAG is included in the NSAG indicated by the information.

### Supplementary Note 6.

The method according to any one of supplementary notes 3 to 5,
wherein the first cell reselection is performed in Access-Stratum (AS) layer in the UE.

### Supplementary Note 7.

The method according to any one of supplementary notes 1 to 6, further comprising:
sending the first NSAG and the first NSAG priority to the AMF.

### Supplementary Note 8.

The method according to supplementary note 7,
wherein the first NSAG and the first NSAG priority are sent to another AMF.

### Supplementary Note 9.

The method according to any one of supplementary notes 1 to 8,
wherein the first NSAG and the first NSAG priority are sent to a Radio Access Network (RAN) node.

### Supplementary Note 10.

The method according to any one of supplementary notes 1 to 9,
wherein at least one of the first NSAG and the first NSAG priority is used for selecting a cell for handover.

### Supplementary Note 11.

The method according to any one of supplementary notes 1 to 10, further comprising:
selecting a second NSAG and a second NSAG priority based on the Allowed NSSAI in a case where Network Slice-Specific Authentication and Authorization (NSSAA) procedure for Single Network Slice Selection Assistance Information (S-NSSAI) included in the Pending NSSAI fails; and
sending the second NSAG and the second NSAG priority to the AMF.

### Supplementary Note 12.

The method according to supplementary note 11,
wherein the second NSAG and the second NSAG priority are selected in Non-Access-Stratum (NAS) layer in the UE.

### Supplementary Note 13.

The method according to supplementary note 11 or 12, further comprising:
performing a second cell reselection based on the second NSAG and the second NSAG priority.

### Supplementary Note 14.

The method according to supplementary note 13,
wherein the second cell reselection is performed in Access-Stratum (AS) layer in the UE.

### Supplementary Note 15.

The method according to any one of supplementary notes 11 to 14,
wherein the second NSAG and the second NSAG priority are sent to another AMF.

### Supplementary Note 16.

The method according to any one of supplementary notes 11 to 15,
wherein the second NSAG and the second NSAG priority are sent to a Radio Access Network (RAN) node.

### Supplementary Note 17.

The method according to any one of supplementary notes 11 to 16,
wherein at least one of the second NSAG and the second NSAG priority is used for selecting a cell for handover.

### Supplementary Note 18.

The method according to any one of supplementary notes 1 to 17, further comprising:
performing a third cell reselection based on S-NSSAI which is included in Configured NSSAI for a Visited Public Land Mobile Network (VPLMN) in a case where the UE roams to the VPLMN.

### Supplementary Note 19.

The method according to any one of supplementary notes 1 to 18,
wherein the first NSAG and the first NSAG priority are selected regardless of status of Network Slice Admission Control (NSAC).

### Supplementary Note 20.

A method of a User Equipment (UE), the method comprising:
communicating with an Access and Mobility Management Function (AMF); and
selecting a first Network Slice Access Stratum (AS) Group (NSAG) and a first NSAG priority based on first Allowed Network Slice Selection Assistance Information (NSSAI) after Network Slice-Specific Authentication and Authorization (NSSAA) procedure for Single Network Slice Selection Assistance Information (S-NSSAI) included in Pending NSSAI completes successfully,
wherein the first Allowed NSSAI includes the S-NSSAI.

### Supplementary Note 21.

The method according to supplementary note 20, further comprising:
selecting a second NSAG and a second NSAG priority based on second Allowed NSSAI before selecting the first NSAG and the first NSAG priority,
wherein the second Allowed NSSAI does not include the S-NSSAI.

### Supplementary Note 22.

The method according to supplementary note 21,
wherein the second NSAG and the second NSAG priority are selected in Non-Access-Stratum (NAS) layer in the UE.

### Supplementary Note 23.

The method according to supplementary note 21 or 22, further comprising:
performing a second cell reselection based on the second NSAG and the second NSAG priority.

### Supplementary Note 24.

The method according to supplementary note 23,
wherein the second cell reselection is performed in Access-Stratum (AS) layer in the UE.

### Supplementary Note 25.

The method according to any one of supplementary notes 21 to 24, further comprising:
sending the second NSAG and the second NSAG priority to the AMF.

### Supplementary Note 26.

The method according to supplementary note 25,
wherein the second NSAG and the second NSAG priority are sent to another AMF.

### Supplementary Note 27.

The method according to any one of supplementary notes 21 to 26,
wherein the second NSAG and the second NSAG priority are sent to a Radio Access Network (RAN) node.

### Supplementary Note 28.

The method according to any one of supplementary notes 21 to 27,
wherein at least one of the second NSAG and the second NSAG priority is used for selecting a cell for handover.

### Supplementary Note 29.

The method according to any one of supplementary notes 20 to 28,
wherein the first NSAG and the first NSAG priority are selected in Non-Access-Stratum (NAS) layer in the UE.

### Supplementary Note 30.

The method according to any one of supplementary notes 20 to 29, further comprising:
performing a first cell reselection based on the first NSAG and the first NSAG priority.

### Supplementary Note 31.

The method according to supplementary note 30,
wherein the performing the first cell reselection includes performing the first cell reselection based on the first NSAG, the first NSAG priority and the Pending NSSAI of at least one of 3GPP access and non-3GPP access.

### Supplementary Note 32.

The method according to supplementary note 30 or 31, further comprising:
receiving information related to a NSAG which is supported by a cell; and
not performing the first cell reselection in a case where the first NSAG is included in the NSAG indicated by the information.

### Supplementary Note 33.

The method according to any one of supplementary notes 30 to 32,
wherein the first cell reselection is performed in Access-Stratum (AS) layer in the UE.

### Supplementary Note 34.

The method according to any one of supplementary notes 20 to 33, further comprising:
sending the first NSAG and the first NSAG priority to the AMF.

### Supplementary Note 35.

The method according to any one of supplementary notes 20 to 34,
wherein the first NSAG and the first NSAG priority are sent to another AMF.

### Supplementary Note 36.

The method according to any one of supplementary notes 20 to 35,
wherein the first NSAG and the first NSAG priority are sent to a Radio Access Network (RAN) node.

### Supplementary Note 37.

The method according to any one of supplementary notes 20 to 36,
wherein at least one of the first NSAG and the first NSAG priority is used for selecting a cell for handover.

### Supplementary Note 38.

The method according to any one of supplementary notes 20 to 37, further comprising:
performing a third cell reselection based on S-NSSAI which is included in Configured NSSAI for a Visited Public Land Mobile Network (VPLMN) in a case where the UE roams to the VPLMN.

### Supplementary Note 39.

The method according to any one of supplementary notes 20 to 38,
wherein the first NSAG and the first NSAG priority are selected regardless of status of Network Slice Admission Control (NSAC).

### Supplementary Note 40.

A method of a communication apparatus, the method comprising:
receiving a first Network Slice Access Stratum (AS) Group (NSAG) and a first NSAG priority; and
sending the first NSAG and the first NSAG priority.

### Supplementary Note 41.

The method according to supplementary note 40,
wherein the sending the first NSAG and the first NSAG priority includes sending the first NSAG and the first NSAG priority to another communication apparatus.

### Supplementary Note 42.

The method according to supplementary note 40,
wherein the sending the first NSAG and the first NSAG priority includes sending the first NSAG and the first NSAG priority to a Radio Access Network (RAN) node.

### Supplementary Note 43.

The method according to any one of supplementary notes 40 to 42,
wherein at least one of the first NSAG and the first NSAG is used for selecting a cell for handover.

### Supplementary Note 44.

The method according to any one of supplementary note 40 to 43, further comprising:
receive a second NSAG and a second NSAG priority; and
sending the second NSAG and the second NSAG priority.

### Supplementary Note 45.

The method according to supplementary note 44,
wherein the sending the second NSAG and the second NSAG priority includes sending the second NSAG and the second NSAG priority to another communication apparatus.

### Supplementary Note 46.

The method according to supplementary note 45,
wherein the sending the second NSAG and the second NSAG priority includes sending the second NSAG and the second NSAG priority to a Radio Access Network (RAN) node.

### Supplementary Note 47.

The method according to any one of supplementary notes 44 to 46,
wherein at least one of the second NSAG and the second NSAG is used for selecting a cell for handover.

### Supplementary Note 48.

A method of a Radio Access Network (RAN) node, the method comprising:
receiving a first Network Slice Access Stratum (AS) Group (NSAG) and a first NSAG priority; and
selecting a cell for handover based on the first NSAG and the first NSAG priority.

### Supplementary Note 49.

The method according to supplementary note 48, further comprising:
performing the handover to the cell.

### Supplementary Note 50.

A User Equipment (UE) comprising:
means for communicating with a communication apparatus; and
means for selecting a first Network Slice Access Stratum (AS) Group (NSAG) and a first NSAG priority based on Allowed Network Slice Selection Assistance Information (NSSAI) and Pending NSSAI.

### Supplementary Note 51.

The UE according to supplementary note 50,
wherein the first NSAG and the first NSAG priority are selected in Non-Access-Stratum (NAS) layer in the UE.

### Supplementary Note 52.

The UE according to supplementary note 50 or 51, further comprising:
means for performing a first cell reselection based on the first NSAG and the first NSAG priority.

### Supplementary Note 53.

The UE according to supplementary note 52, further comprising:
means for performing the first cell reselection based on the first NSAG, the first NSAG priority and the Pending NSSAI of at least one of 3GPP access and non-3GPP access.

### Supplementary Note 54.

The UE according to supplementary note 52 or 53, further comprising:
means for receiving information related to a NSAG which is supported by a cell; and
means for not performing the first cell reselection in a case where the first NSAG is included in the NSAG indicated by the information.

### Supplementary Note 55.

The UE according to any one of supplementary notes 52 to 54,
wherein the first cell reselection is performed in Access-Stratum (AS) layer in the UE.

### Supplementary Note 56.

The UE according to any one of supplementary notes 50 to 55, further comprising:
means for sending the first NSAG and the first NSAG priority to the communication apparatus.

### Supplementary Note 57.

The UE according to supplementary note 56,
wherein the first NSAG and the first NSAG priority are sent to another communication apparatus.

### Supplementary Note 58.

The UE according to any one of supplementary notes 50 to 57,
wherein the first NSAG and the first NSAG priority are sent to a Radio Access Network (RAN) node.

### Supplementary Note 59.

The UE according to any one of supplementary notes 50 to 58,
wherein at least one of the first NSAG and the first NSAG priority is used for selecting a cell for handover.

### Supplementary Note 60.

The UE according to any one of supplementary notes 50 to 59, further comprising:
means for selecting a second NSAG and a second NSAG priority based on the Allowed NSSAI in a case where Network Slice-Specific Authentication and Authorization (NSSAA) procedure for Single Network Slice Selection Assistance Information (S-NSSAI) included in the Pending NSSAI fails; and
means for sending the second NSAG and the second NSAG priority to the communication apparatus.

### Supplementary Note 61.

The UE according to supplementary note 60,
wherein the second NSAG and the second NSAG priority are selected in Non-Access-Stratum (NAS) layer in the UE.

### Supplementary Note 62.

The UE according to supplementary note 60 or 61, further comprising:
means for performing a second cell reselection based on the second NSAG and the second NSAG priority.

### Supplementary Note 63.

The UE according to supplementary note 62,
wherein the second cell reselection is performed in Access-Stratum (AS) layer in the UE.

### Supplementary Note 64.

The UE according to any one of supplementary notes 60 to 63,
wherein the second NSAG and the second NSAG priority are sent to another communication apparatus.

### Supplementary Note 65.

The UE according to any one of supplementary notes 60 to 64,
wherein the second NSAG and the second NSAG priority are sent to a Radio Access Network (RAN) node.

### Supplementary Note 66.

The UE according to any one of supplementary notes 60 to 65,
wherein at least one of the second NSAG and the second NSAG priority is used for selecting a cell for handover.

### Supplementary Note 67.

The UE according to any one of supplementary notes 50 to 66, further comprising:
means for performing a third cell reselection based on S-NSSAI which is included in Configured NSSAI for a Visited Public Land Mobile Network (VPLMN) in a case where the UE roams to the VPLMN.

### Supplementary Note 68.

The UE according to any one of supplementary notes 50 to 67,
wherein the first NSAG and the first NSAG priority are selected regardless of status of Network Slice Admission Control (NSAC).

### Supplementary Note 69.

A User Equipment (UE) comprising:
means for communicating with a communication apparatus; and
means for selecting a first Network Slice Access Stratum (AS) Group (NSAG) and a first NSAG priority based on first Allowed Network Slice Selection Assistance Information (NSSAI) after Network Slice-Specific Authentication and Authorization (NSSAA) procedure for Single Network Slice Selection Assistance Information (S-NSSAI) included in Pending NSSAI completes successfully,
wherein the first Allowed NSSAI includes the S-NSSAI.

### Supplementary Note 70.

The UE according to supplementary note 69, further comprising:
means for selecting a second NSAG and a second NSAG priority based on second Allowed NSSAI before selecting the first NSAG and the first NSAG priority,
wherein the second Allowed NSSAI does not include the S-NSSAI.

### Supplementary Note 71.

The UE according to supplementary note 70,
wherein the second NSAG and the second NSAG priority are selected in Non-Access-Stratum (NAS) layer in the UE.

### Supplementary Note 72.

The UE according to supplementary note 70 or 71, further comprising:
means for performing a second cell reselection based on the second NSAG and the second NSAG priority.

### Supplementary Note 73.

The UE according to supplementary note 72,
wherein the second cell reselection is performed in Access-Stratum (AS) layer in the UE.

### Supplementary Note 74.

The UE according to any one of supplementary notes 70 to 73, further comprising:
means for sending the second NSAG and the second NSAG priority to the communication apparatus.

### Supplementary Note 75.

The UE according to supplementary note 74,
wherein the second NSAG and the second NSAG priority are sent to another communication apparatus.

### Supplementary Note 76.

The UE according to any one of supplementary notes 70 to 75,
wherein the second NSAG and the second NSAG priority are sent to a Radio Access Network (RAN) node.

### Supplementary Note 77.

The UE according to any one of supplementary notes 70 to 76,
wherein at least one of the second NSAG and the second NSAG priority is used for selecting a cell for handover.

### Supplementary Note 78.

The UE according to any one of supplementary notes 69 to 77,
wherein the first NSAG and the first NSAG priority are selected in Non-Access-Stratum (NAS) layer in the UE.

### Supplementary Note 79.

The UE according to any one of supplementary notes 69 to 78, further comprising:
means for performing a first cell reselection based on the first NSAG and the first NSAG priority.

### Supplementary Note 80.

The UE according to supplementary note 79,
wherein the performing the first cell reselection includes performing the first cell reselection based on the first NSAG, the first NSAG priority and the Pending NSSAI of at least one of 3GPP access and non-3GPP access.

### Supplementary Note 81.

The UE according to supplementary note 79 or 80, further comprising:
means for receiving information related to a NSAG which is supported by a cell; and
means for not performing the first cell reselection in a case where the first NSAG is included in the NSAG indicated by the information.

### Supplementary Note 82.

The UE according to any one of supplementary notes 79 to 81,
wherein the first cell reselection is performed in Access-Stratum (AS) layer in the UE.

### Supplementary Note 83.

The UE according to any one of supplementary notes 69 to 82, further comprising:
means for sending the first NSAG and the first NSAG priority to the communication apparatus.

### Supplementary Note 84.

The UE according to any one of supplementary notes 69 to 83,
wherein the first NSAG and the first NSAG priority are sent to another communication apparatus.

### Supplementary Note 85.

The UE according to any one of supplementary notes 69 to 84,
wherein the first NSAG and the first NSAG priority are sent to a Radio Access Network (RAN) node.

### Supplementary Note 86.

The UE according to any one of supplementary notes 69 to 85,
wherein at least one of the first NSAG and the first NSAG priority is used for selecting a cell for handover.

### Supplementary Note 87.

The UE according to any one of supplementary notes 69 to 86, further comprising:
means for performing a third cell reselection based on S-NSSAI which is included in Configured NSSAI for a Visited Public Land Mobile Network (VPLMN) in a case where the UE roams to the VPLMN.

### Supplementary Note 88.

The UE according to any one of supplementary notes 69 to 87,
wherein the first NSAG and the first NSAG priority are selected regardless of status of Network Slice Admission Control (NSAC).

### Supplementary Note 89.

A communication apparatus comprising:
means for receiving a first Network Slice Access Stratum (AS) Group (NSAG) and a first NSAG priority; and
means for sending the first NSAG and the first NSAG priority.

### Supplementary Note 90.

The communication apparatus according to supplementary note 89, further comprising:
means for sending the first NSAG and the first NSAG priority to another communication apparatus.

### Supplementary Note 91.

The communication apparatus according to supplementary note 89, further comprising:
means for sending the first NSAG and the first NSAG priority to a Radio Access Network (RAN) node.

### Supplementary Note 92.

The communication apparatus according to any one of supplementary notes 89 to 91,
wherein at least one of the first NSAG and the first NSAG is used for selecting a cell for handover.

### Supplementary Note 93.

The communication apparatus according to any one of supplementary notes 89 to 92, further comprising:
means for receive a second NSAG and a second NSAG priority; and
means for sending the second NSAG and the second NSAG priority.

### Supplementary Note 94.

The communication apparatus according to supplementary note 93,
wherein the sending the second NSAG and the second NSAG priority includes sending the second NSAG and the second NSAG priority to another communication apparatus.

### Supplementary Note 95.

The communication apparatus according to supplementary note 94,
wherein the sending the second NSAG and the second NSAG priority includes sending the second NSAG and the second NSAG priority to a Radio Access Network (RAN) node.

### Supplementary Note 96.

The communication apparatus according to any one of supplementary notes 93 to 95,
wherein at least one of the second NSAG and the second NSAG is used for selecting a cell for handover.

### Supplementary Note 97.

A Radio Access Network (RAN) node comprising:
means for receiving a first Network Slice Access Stratum (AS) Group (NSAG) and a first NSAG priority; and
means for selecting a cell for handover based on the first NSAG and the first NSAG priority.

### Supplementary Note 98.

The RAN node according to supplementary note 97, further comprising:
means for performing the handover to the cell.

### Supplementary Note 99.

A method of a User Equipment (UE), the method comprising:
communicating with a communication apparatus; and
sending, to the communication apparatus, first Single Network Slice Selection Assistance Information (S-NSSAI) included in Pending Network Slice Selection Assistance Information (NSSAI).

### Supplementary Note 100.

The method according to supplementary note 99,
wherein the sending the first S-NSSAI includes sending the first S-NSSAI after performing a network slice based cell reselection.

### Supplementary Note 101.

The method according to supplementary note 100,
wherein the network slice based cell reselection is performed for second S-NSSAI, and
wherein the second S-NSSAI is different from the first S-NSSAI.

### Supplementary Note 102.

The method according to supplementary note 101,
wherein the sending the first S-NSSAI includes sending the first S-NSSAI and Requested NSSAI including the second S-NSSAI.

### Supplementary Note 103.

The method according to supplementary note 102,
wherein the first S-NSSAI and the Requested NSSAI are included in a registration request message.

### Supplementary Note 104.

The method according to any one of supplementary notes 99 to 103,
wherein the sending the first S-NSSAI includes sending the first S-NSSAI in a case where the UE has the Pending NSSAI.

### Supplementary Note 105.

A method of a User Equipment (UE), the method comprising:
communicating with a communication apparatus; and
sending, to the communication apparatus, information indicating that the UE is not interested in Single Network Slice Selection Assistance Information (S-NSSAI) included in Pending Network Slice Selection Assistance Information (NSSAI).

### Supplementary Note 106.

A method of a communication apparatus, the method comprising:
receiving first Single Network Slice Selection Assistance Information (S-NSSAI) included in Pending Network Slice Selection Assistance Information (NSSAI); and
aborting Network Slice-Specific Authentication and Authorization (NSSAA) procedure for the first S-NSSAI.

### Supplementary Note 107.

The method according to supplementary note 106,
wherein the first S-NSSAI is included in a registration request message,
wherein the registration request message includes Requested NSSAI,
wherein the Requested NSSAI includes second S-NSSAI, and
wherein the second S-NSSAI is different from the first S-NSSAI.

### Supplementary Note 108.

The method according to supplementary note 106 or 107,
wherein the aborting the NSSAA procedure includes aborting the NSSAA procedure in a case where the NSSAA procedure is ongoing.

### Supplementary Note 109.

The method according to any one of supplementary notes 106 to 108, further comprising:
removing the first S-NSSAI from Allowed NSSAI in a case where the NSSAA procedure completes successfully.

### Supplementary Note 110.

The method according to any one of supplementary notes 106 to 109, further comprising:
including the first S-NSSAI in Rejected NSSAI in a case where the NSSAA procedure fails.

### Supplementary Note 111.

A User Equipment (UE) comprising:
means for communicating with a communication apparatus; and
means for sending, to the communication apparatus, first Single Network Slice Selection Assistance Information (S-NSSAI) included in Pending Network Slice Selection Assistance Information (NSSAI).

### Supplementary Note 112.

The UE according to supplementary note 111, further comprising:
means for sending the first S-NSSAI after performing a network slice based cell reselection.

### Supplementary Note 113.

The UE according to supplementary note 112,
wherein the network slice based cell reselection is performed for second S-NSSAI, and wherein the second S-NSSAI is different from the first S-NSSAI.

### Supplementary Note 114.

The UE according to supplementary note 113, further comprising:
means for sending the first S-NSSAI and Requested NSSAI including the second S-NSSAI.

### Supplementary Note 115.

The UE according to supplementary note 114,
wherein the first S-NSSAI and the Requested NSSAI are included in a registration request message.

### Supplementary Note 116.

The UE according to any one of supplementary notes 111 to 115,
means for sending the first S-NSSAI in a case where the UE has the Pending NSSAI.

### Supplementary Note 117.

A User Equipment (UE) comprising:
means for communicating with a communication apparatus; and
means for sending, to the communication apparatus, information indicating that the UE is not interested in Single Network Slice Selection Assistance Information (S-NSSAI) included in Pending Network Slice Selection Assistance Information (NSSAI).

### Supplementary Note 118.

A communication apparatus comprising:
means for receiving first Single Network Slice Selection Assistance Information (S-NSSAI) included in Pending Network Slice Selection Assistance Information (NSSAI); and means for aborting Network Slice-Specific Authentication and Authorization (NSSAA) procedure for the first S-NSSAI.

### Supplementary Note 119.

The communication apparatus according to supplementary note 118,
wherein the first S-NSSAI is included in a registration request message,
wherein the registration request message includes Requested NSSAI,
wherein the Requested NSSAI includes second S-NSSAI, and
wherein the second S-NSSAI is different from the first S-NSSAI.

### Supplementary Note 120.

The communication apparatus according to supplementary note 118 or 119, further comprising:
means for aborting the NSSAA procedure in a case where the NSSAA procedure is ongoing.

### Supplementary Note 121.

The communication apparatus according to any one of supplementary notes 118 to 120, further comprising:
means for removing the first S-NSSAI from Allowed NSSAI in a case where the NSSAA procedure completes successfully.

### Supplementary Note 122.

The communication apparatus according to any one of supplementary notes 118 to 121, further comprising:
means for including the first S-NSSAI in Rejected NSSAI in a case where the NSSAA procedure fails.

This application is based upon and claims the benefit of priority from Indian provisional patent application No. 202211043223, filed on Jul. 28, 2022, the disclosure of which is incorporated herein in its entirety by reference.

### REFERENCE SIGNS LIST

3 UE
31 transceiver circuit
32 antennas
33 controller
34 user interface
35 Universal Subscriber Identity Module (USIM)
36 memory
361 operating system
362 communications control module
3621 transceiver control module
301 UE NAS
302 UE AS
5 (R)AN node
51 transceiver circuit
52 antennas
53 network interface
54 controller
55 memory
551 operating system
552 communications control module
5521 transceiver control module
60 Radio Unit (RU)
601 transceiver circuit
602 antennas
603 network interface
604 controller
605 memory
6051 operating system
6052 communications control module
60521 transceiver control module
61 Distributed Unit (DU)
611 transceiver circuit
612 network interface
613 controller
614 memory
6141 operating system
6142 communications control module
61421 transceiver control module
62 Centralized Unit (CU)
621 transceiver circuit
622 network interface
623 controller
624 memory
6241 operating system
6242 communications control module
62421 transceiver control module 7 core network
70 access and mobility management function (AMF)
701 transceiver circuit
702 network interface
703 controller
704 memory
7041 operating system
7042 communications control module
70421 transceiver control module
71 Session Management Function (SMF)
72 User Plane Function (UPF)
73 Policy Control Function (PCF)
731 transceiver circuit
732 network interface
733 controller
734 memory
7341 operating system
7342 communications control module
73421 transceiver control module
74 Authentication Server Function (AUSF)
741 transceiver circuit
742 network interface
743 controller
744 memory
7441 operating system
7442 communications control module
74421 transceiver control module
75 Unified Data Management (UDM)
751 transceiver circuit
752 network interface
753 controller
754 memory
7541 operating system
7542 communications control module
75421 transceiver control module
76 Network Slice Selection Function (NSSF)
761 transceiver circuit
762 network interface
763 controller
764 memory
7641 operating system
7642 communications control module
76421 transceiver control module
20 data network
201 AAA

What is claimed is:

1.-98. (canceled)

99. A method performed by a user equipment (UE) supporting a Stand-alone Non-Public Network (SNPN), the method comprising:
sending, to an Access and Mobility Management Function (AMF) supporting the SNPN, a Registration Request message; and
receiving, from the AMF, a Registration Accept message comprising a first priority related to a Network Slice Access Stratum Group (NSAG), and
determining whether to perform a cell reselection based on the first priority for the SNPN.

100. The method according to claim 99, wherein
the method further comprises receiving, from a base station, a system information block (SIB) 16 comprising a second priority related to the NSAG, and
the determining comprises determining whether to perform the cell reselection based on the first priority for the SNPN and the second priority for the SNPN.

101. A user equipment (UE) supporting a Stand-alone Non-Public Network (SNPN), the UE comprising:
one or more memories storing instructions; and
one or more processors configured to process the instructions to control the UE to:
send, to an Access and Mobility Management Function (AMF) supporting the SNPN, a Registration Request message; and
receive, from the AMF, a Registration Accept message comprising a first priority related to a Network Slice Access Stratum Group (NSAG), and
determine whether to perform a cell reselection based on the first priority for the SNPN.

102. The UE according to claim 101, wherein
the one or more processors are configured to process the instructions to control the UE to:
receive, from a base station, a system information block (SIB) 16 comprising a second priority related to the NSAG, and
determine whether to perform the cell reselection based on the first priority for the SNPN and the second priority for the SNPN.
